(19) United States
(12) Patent Application Publication
(10) Pub. No.: US 2009/0106132 A1
(43) Pub. Date: Apr. 23, 2009

(54) Electronic billing system utilizing a universal billing format data transmission

(76) Inventors: Gabriela Isturiz, Pittsburgh, PA (US); Daniel Garcia, Pittsburgh, PA (US)

Correspondence Address: OCCHIUTI ROHLICEK & TSAO, LLP, 10 FAWCETT STREET, CAMBRIDGE, MA, 02138, US

(21) Appl. No.: 12/283,959

(22) Filed: Sep. 17, 2008

Related U.S. Application Data
(63) Continuation of application No. 10/431,290, filed on May 7, 2003, now abandoned.
(60) Provisional application No. 60/378,578, filed on May 7, 2002.

(51) Int. Cl. G06Q 30/00

(52) U.S. Cl. 705/34

(57) ABSTRACT

The electronic billing system comprises a means for isolating the service provider from directly engaging the billing guidelines of the consumer client through the use of a universal billing format file and a billing hub module. The billing process comprises a service provider computer system, on which specific billing data is stored, a service provider application that accesses the billing data and compiles a universal billing format file, a validation process to ensure that the billing data satisfies billing guidelines supplied by the service consumer, and a billing hub module that receives the universal billing format file and reconfigures the individual billing data entries into a client invoice that complies with the billing guidelines supplied by the service consumer.

### CROSS REFERENCE TO RELATED APPLICATION

This application is a continuation application and claims the benefit of U.S. application Ser. No. 10/431,290 filed May 7, 2003. This application also claims the benefit of U.S. Provisional Application No. 60/378,578 filed May 7, 2002.

### FIELD OF THE INVENTION/BACKGROUND INFORMATION

The invention relates generally to electronic billing systems. The billing process has traditionally been accomplished by generating paper hardcopies of invoices that are sent to clients in order to request payment for services rendered. Paper hardcopies of invoices are produced either through manual entry of data or through an automated process. Large corporations often struggle to effectively manage what often amounts to thousands of paper invoices.

Before authorizing payment to an accounting or law firm, service consumers typically review invoices to ensure compliance with their billing guidelines. This is particularly true of corporate clients that establish strict protocols for receiving invoices. Reasons clients often wish to compare invoices of multiple services providers include: to determine the most cost-effective firms, to determine the factors that cause cases with similar fact patterns to cost differing amounts, to determine appropriate benchmarks for the systematic evaluation of costs and to develop a data repository of costs for specific legal or accounting services.

Typically, each individual client has their own set of internal content and formatting guidelines for receiving invoices. Consequently, the billing departments of law firm and accounting service providers are faced with the time-consuming challenge of complying with a broad range of unique and specialized billing requirements for each client. As more clients request service providers to initiate “task based billing” and increase their efforts to manage outside legal costs more effectively, law and accounting firms are faced with the increasingly burdensome task of complying with myriad formatting requests. For example, in order for law firms to be competitive they have to supply the necessary resources and infrastructure to keep track of and comply with the billing requirements of each of their clients or be prone to losing business. Law firms invest a significant amount time, personnel and money to comply with the billing requirements of clients. When clients change their billing parameters, law firms need to adjust their billing procedures accordingly. If law firms submit invoices that do not contain the client's requested content and format, the law firm has effectively delayed their receipt of payment and lost money.

Generally, clients work with multiple service providers and each client typically receives multiple invoices from each service provider. Before clients pay invoices submitted to them by service providers, they have to validate the invoice to ensure that the invoice received is in compliance with their billing guidelines. Most invoices sent to clients that are rejected are rejected because the service provider neglected to follow the billing guidelines of the client. When service providers fail to follow billing guidelines, consumers need to approach each individual service provider and send the files back for correction. Furthermore, when clients elect to change their billing guidelines, they need to contact each individual service provider to notify them of the new changes.

In 1994, a joint task of representatives from the American Bar Association, American Corporate Counsel Association and a group of corporations and law firms joined together to develop a mutually acceptable unified coding system. This initiative produced a uniform task-based system for litigation, the Litigation Code Set or Uniform Task Based Management System (UTBMS). The goals of the Litigation Code Set are to: enable the client and counsel to plan and maintain an efficient and effective litigation; facilitate communication of the tasks and cost of litigation and any variations from the expected norm; provide each client and law firm with a means to individually understand and compare the cost of litigation, for greater efficiency and as a foundation for the use of alternate billing arrangements; and harmonize the various task-based efforts to ease widespread adoption of simple, concise and flexible task-based management approaches. The intention of the Litigation Code Set is to minimize multiple interpretations and options for coding service entries as well as facilitate the transition from paper bills to electronic bills.

However, there are no standards to uniformly bill legal invoices electronically. The absence of a universal billing format caused many service consumers to create their own billing formats to meet their own needs. As a consequence, many law firms' administrative organizations are faced with the challenge of complying with a broad range of specialized billing requirements, each unique to one individual service consumer. As service consumer's expand their use of “task-based billing” and broaden their efforts to manage outside counsel costs more effectively, law firms face the prospect of overwhelming complexity as they strive to comply with the requests of many different service consumers. Accordingly, a need exists for a universal billing format applicable to electronic invoicing.

Moreover, as service providers find the Litigation Code Set insufficient for their business needs, they often resort to create code sets of their own, further complicating matters for law firms. Accordingly, a need exists for an automated process of determining the appropriate litigation codes for charges included with invoices sent to service consumers.

### SUMMARY OF THE INVENTION

An aspect of the present invention is to provide a computer-assisted billing system comprising a first computer system that is operable by at least one user to enter and store billing data, a second computer system capable of receiving a billing data file, and a universal billing format application, in data communication with the first computer system and the second computer system, comprising the means for extracting electronic billing data from the first computer system, arranging the billing data from the first computer system into a pre-existing billing data format, generating the billing data file, and electronically transmitting the billing data file to the second computer system.

Another aspect of the present invention is to provide a computer-implemented method of generating an invoice, comprising the steps of entering and storing data into a first computer system, extracting electronic billing data from the first computer system, arranging the billing data from the first computer system into a pre-existing billing data format, generating a billing data file, and electronically transmitting the billing data file to a second computer system capable of receiving the billing data file.

Another aspect of the present invention is to provide a computer-readable medium having instructions which, when executed by a processor, cause the processor to perform the steps of extracting electronic billing data from a first computer system, arranging the billing data from a first computer system into a pre-existing billing data format, generating a billing data file, and electronically transmitting the billing data to a second computer system.

Another aspect of the present invention is to provide an apparatus comprising means for extracting electronic billing data from a first computer system, means for arranging the billing data from a first computer system into a pre-existing billing data format, means for generating a billing data file, and means for electronically transmitting the billing data to a second computer system.

Another aspect of the present invention is to provide a system comprising a billing data entry computer, a billing file converting computer, a universal billing format module in communication with the billing data entry computer and the billing file converting computer, and billing data arranged in a pre-existing billing format in communication with the billing data entry computer and the billing file converting computer.

Another aspect of the present invention is to provide a system comprising a processor, and a memory in communication with the processor, the memory having stored thereon a set of ordered data and instructions which, when executed by the processor, cause the processor to perform the steps of extracting electronic billing data from a first computer system, arranging the billing data from a first computer system into a pre-existing billing data format, generating a billing data file, and electronically transmitting the billing data to a second computer system.

### BRIEF DESCRIPTION OF THE DRAWINGS

FIGS. 1 and 2 are diagrams illustrating an electronic billing system.

FIGS. 3-5 are diagrams illustrating a process flow through the system of FIG. 1.

FIG. 6 is diagram illustrating the business logic and incorporating a graphic user interface (GUI) display.

FIG. 7 is a diagram illustrating the billing protocol.

FIG. 8 is a diagram illustrating the billing protocol structure when using a dynamically generated web page.

FIG. 9 is a diagram illustrating the use-case diagram for the client sub-system.

FIG. 10 is a diagram illustrating the select invoice feature of the use-case.

FIG. 11 is a diagram illustrating the generate universal billing format file feature of the use-case.

FIG. 12 is a diagram illustrating the transmittal of the universal billing format file feature of the use-case, and the optional saving of a copy of the universal billing format file into the service provider's computer system.

FIG. 13 is a diagram illustrating the use-case diagram for the electronic billing hub subsystem.

FIG. 14 is a diagram illustrating the generate electronic invoice feature of the use-case.

FIG. 15 is a diagram illustrating the send electronic invoice feature of the use-case.

FIG. 16 is a diagram illustrating the receive notification feature of the use-case.

FIG. 17 is a diagram illustrating the class diagram system overview.

FIG. 18 is a diagram illustrating the class diagram of the run-time configuration of the system when the user is running a billing session.

FIG. 19 is a diagram illustrating the run-time configuration of the system when the user is running a configuration session.

FIG. 20 is a diagram illustrating the run-time configuration of the system when the user is running a billing session when the billing hub module is deployed to be used through the Internet.

FIG. 21 is a diagram illustrating the class diagram for the components that facilitate creating a universal billing format file using the LEDES 2000 standard.

FIG. 22 is a diagram illustrating the class diagram for the hub link.

FIGS. 23-28 are screen printouts illustrating the selection of invoices and the validation of billing data.

FIGS. 29-32 are screen printout illustrating the submission of invoices.

FIG. 33 is a screen printout illustrating the formatted invoice.

FIGS. 34-36 are screen printouts illustrating the rejection of invoices and invoice history.

FIGS. 37-44 are screen printouts illustrating the configuration of the billing hub.

FIGS. 45-47 are screen printouts illustrating the customer support features.

### DETAILED DESCRIPTION OF PREFERRED EMBODIMENTS

The present invention follows a business to business model that acts as an integrator between service providers, such as law firms and accounting firms, and service consumers, such as insurance companies and large corporation clients. However, it will be understood that the invention may be applicable to other types of service providers and/or service consumers.

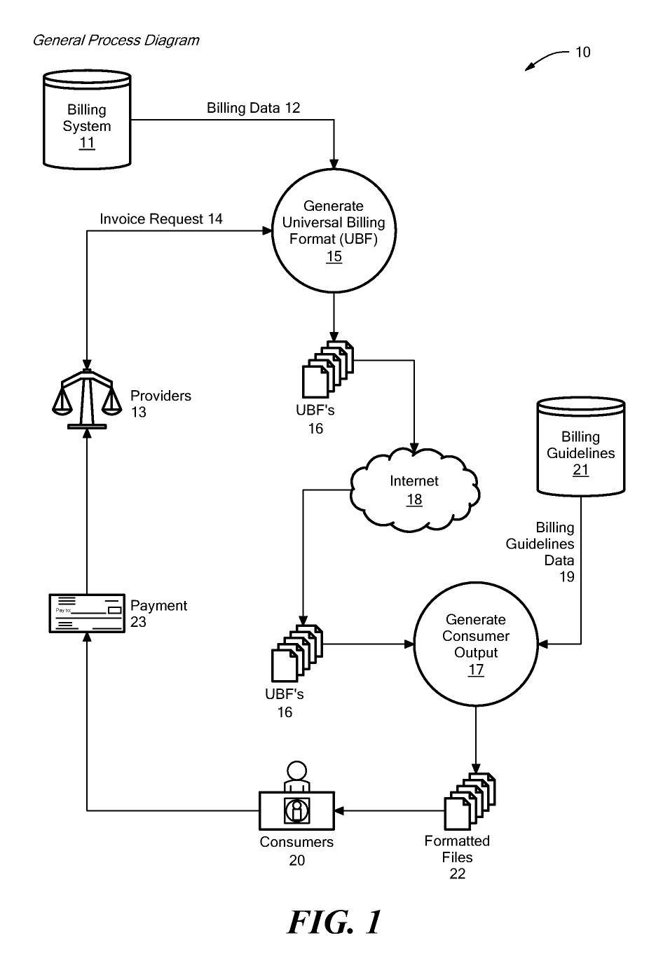

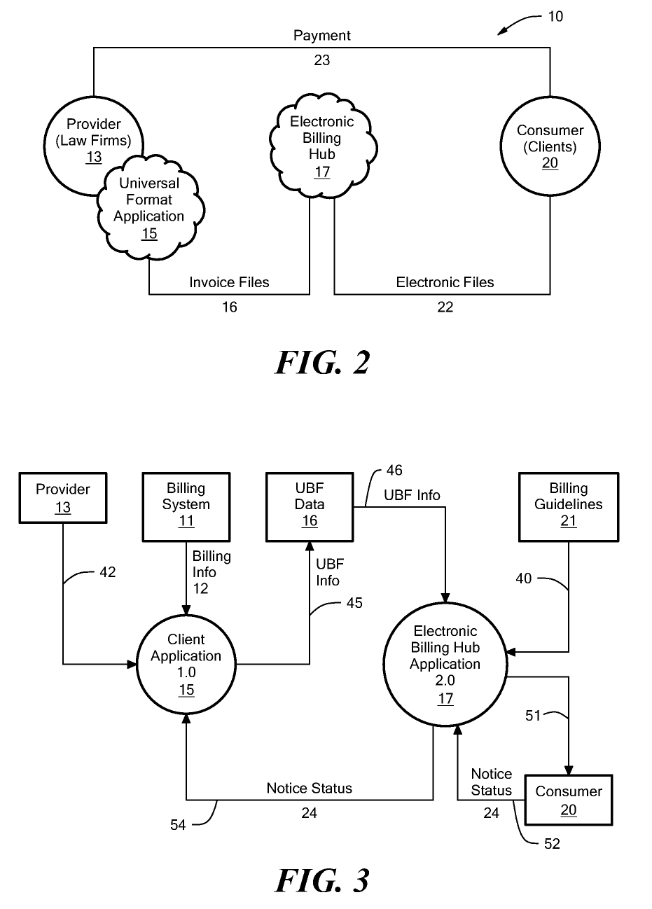

FIGS. 1 and 2 are diagrams illustrating an electronic billing process 10. Billing process 10 includes a service provider computer system 11, on which billing data 12 relating to services preformed by a service provider 13 (i.e. a law firm, an accounting firm, etc.) may be entered and stored, and through which a service provider 13 can execute the software portions of the service provider billing computer system 11. The user of the service provider computer system 11 may be, for example, an attorney, an accountant, an individual of a service provider billing department, or any other individual authorized to submit invoices to a service consumer. Service provider computer system 11 may be any type of computer, computer system or computer network as well as handheld personal digital assistant (PDA) or similar type devices. In one embodiment of the present invention, the service provider computer system comprises: a personal computer (PC), a mainframe computer, a server system or a workstation. In another embodiment, billing data 12 may be stored in the service provider computer system 11 in a database on magnetic recording medium. In another embodiment, individual billing data 12 may be entered in discrete billing fields, comprising billing field entries.

A user of the service provider computer system 11 initiates the billing process by sending an invoice request 14 to a service provider application 15 requesting to be paid by the service consumer 20 for services rendered. In one embodiment of the present invention, the service provider application 15 may be physically located on the service provider computer system 11. In an alternative embodiment, the service provider application 15 may be located on a remote computer system that is in data communication with the service provider computer system 11. In another embodiment of the present invention, the service provider application 15 may be located at least in part on the service provider computer system 11 and at least in part on a remote computer system that is in data communication with the service provider computer system 11. As used herein, the term “in data communication” means a first device, system and/or application that is capable of transmitting, receiving, and/or transmitting and receiving information from, and/or to a second device, system and/or application.

In one embodiment of the present invention, the service provider computer system 11 executes the various software portions of the service provider application 15.

In another embodiment, the software portion of the service provider application 15 could be executed using, for example, software resident on the service provider computer system 11, software that is located on a remote computer system that is in data communication with the service provider computer system 11 and the service provider application 15, or software that is automatically downloaded, installed and upgraded from the Internet to a portion of the service provider application 15.

The software portion of the service provider application 15 accesses the service provider computer system 11 to obtain billing data 12 from the service provider computer system 11. In one embodiment, the service provider application 15 obtains permission from the service provider computer system 11 prior to accessing the billing data 12 stored on the service provider computer system 11. The service provider application 15, imports a copy of the billing data 12 from the service provider computer system 11 and compiles the billing data 12 into an established and pre-existing universal billing format file 16. The universal billing format file 16 includes all billing data 12 that could potentially be required to generate a client invoice 22. Service provider application 15 arranges the billing data 12 from the service provider computer system 11 in a standardized format that is structurally identical for all invoice requests 14. Although the structure of the universal billing format file 16 is identical for all invoice requests 14, the individual billing data 12 field entries contained within the universal billing format file 16 are distinct and specific to each invoice request 14. The service provider 13 does not have to directly engage the billing guidelines 21 of any of their service consumer clients 20. Each invoice request 14 is handled identically from the service provider's 13 perspective through the transmission of the universal billing format 16.

The universal billing format file 16 is transmitted from the service provider application 15 to the billing hub module 17. In one embodiment of the present invention, the universal billing format file 16 is transmitted to the billing hub module 17 by communication means 18. As used herein, the term “communication means” includes wire and wireless methods of creating data communication between at least a first device, system and/or application and at least a second device, system and/or application. In one embodiment of the present invention, the communication means comprises the Internet, a local area network or the public switched telephone network (PSTN). In another embodiment, communication means includes transport methods such as Remote Procedure Call (RPC), HyperText Transfer Protocol (HTTP), Simple Object Access Protocol (SOAP), and Application Message Queues (for example through MicroSoft Message Queue) that allow access to the services in the service provider application 15 and the billing hub module 17. The service provider application 15 supports direct access through stored procedures and through the most widely accepted database Application Programming Interfaces (APIs), including Open DataBase Connectivity (ODBC) and OLEDB. In another embodiment, communication means between the service provider computer system 11 an the service provider application 15 can be achieved through variations of a Remote Procedure Call framework and through messaging protocol. In another embodiment, security features including SSL, server certificates, username-password pairs and session timeout are used in conjunction with the communication means to provide a heightened level of security.

The billing hub module 17 may comprise any type of computer, computer system or network of computers. In one embodiment of the present invention, the billing hub module 17 may comprise a PC, a mainframe computer, a server system, a workstation or any combinations thereof as well as any handheld personal digital assistant (PDA) or similar type devices. Software resident on the billing hub module 17 receives the universal billing format file 16 from the service provider application 15. Software resident on the billing hub module 17 also receives billing guideline data 19 from service consumers 20. In one embodiment of the present invention, the software is located on a remote computer system and is in data communication with the billing hub module 17.

Service consumers 20 or assigned personnel, enter billing guidelines 21 into a device, system or application in data communication with the billing hub module 17. The billing hub module 17 stores the billing guidelines 21 so that it can later use them to validate and format the billing data into client invoices 22. Billing guidelines 21 typically comprise specific restrictions pertaining to the formatting, content and processing of invoices. The software resident on billing hub module 17 reprocesses the billing data 12 contained in the universal billing format file 16 and generates therefrom a client invoice 22 that complies with billing guidelines 21 dictated by the service consumer 20.

The client invoice 22, is transmitted from the billing hub module 17 to the service consumer. Typically, the client invoice 22 is electronically transmitted by communication means 18 to the service consumer's accounts receivable computer system. If the service consumer 20 is satisfied that the client invoice 22, the service consumer 20 will authorize that the service provider 13 receive payment 23 for services rendered.

FIGS. 3-5 are diagrams illustrating a process flow through the system 10 of FIG. 1. In FIGS. 3-5, external entities are represented by rectangles underscored by shaded areas, data entries are represented by rectangles and data processes are represented by circles. FIG. 3 illustrates the macro processes and the main data entities.

At introductory step 40, a service consumer 20 electronically transmits billing guidelines 21 to the billing hub module 17 through communication means 18. The billing guidelines 21 can comprise any requirements the service consumer 20 desires to impose on client invoices 22 received from the service provider 13. The billing guidelines 21 typically comprise the service consumer's 20 desired client invoice format, invoice content requirements and invoice processing guidelines. In one embodiment of the present invention, the billing hub module 17 may comprise a database containing pre-entered standard billing guidelines fields. In another embodiment, the service consumer 20 may submit billing guidelines 21 that are not included in the pre-entered standard billing guidelines fields of billing hub module 17. The billing hub module 17 may further comprise customizable or user-defined fields to receive billing guidelines from the service consumer 20 that are not included in the pre-entered standard billing guidelines. In another embodiment, the billing hub module 17 allows the service consumer to delete or remove pre-entered standard billing guidelines entries.

At step 41, the billing hub module 17 records the billing guidelines 21 received by the service consumer 20 in the memory of the billing hub module 17 or the software associated therewith. In one embodiment, the billing hub module 17 records the billing guidelines 21 in pre-entered standard billing guideline fields and/or user-defined fields.

In one embodiment of the present invention, when a service consumer elects to change billing guidelines 21, the service consumer submits one updated request to the billing hub module 17 to ensure that every service provider 13 that uses the method of the present invention will, from that point on, submit client invoices 22 to the service consumer 20 in the proper form. The billing hub module 17 will subsequently update its internal processes but the service providers 13 will not have to make any modifications to their invoice submission process.

At step 42, a service provider 13 can enter billing data 12 into the service provider computer system 11. Typical information entered into the service provider computer system 11 may include all information necessary to record time and expenses, identify the parties involved, and all information necessary to determine where charges and payments are to be directed.

Examples of typical billing data include: timekeeper information, client information, case information, timecard information, costcard information and bill information. As used herein, the term “timekeeper” means any individual authorized to charge a client for services rendered and track the number of hours worked on a specified project. Timekeepers, such as attorneys, paralegals, accountants and other like professionals, keep track of the time they expend working on cases whether the fee arrangement is hourly or fixed. Examples of timekeeper information include: timekeeper identification number, initials, last name, first name, title, practice area and billing rate.

Client information typically includes any billing information pertaining to client consumers that are receiving services from service providers. Examples of client information include: client identification number, name or responsible party and address.

Case information typically includes any billing information pertaining to disbursements, costs and the services provided by timekeepers for a certain consumer client. Generally, many timekeepers can work on each case and each case corresponds to only one consumer client responsible for receiving the invoice. Examples of case information include: case identification number, name, description, client number, case type, fee arrangement, contact name, responsible service provider, billing address, case open date, case close date, party names and timekeepers assigned to the case.

Timecard information typically includes any billing information pertaining to a timekeeper's number of hours worked, billing rate, total dollar amount due to be paid and descriptions of every activity performed for a particular case. Examples of timecard information include: invoice number, timekeeper identification, rate, hours worked, total amount due to be paid, activity code and description of activities performed.

Costcard information typically includes any billing information pertaining to any disbursements paid or costs incurred for a particular case. Examples of costcard information include: invoice identification number, timekeeper information, quantity, amount, expense codes and description of the disbursement or costs incurred, such as photocopies, mileage and other expenses.

Bill information typically includes all information pertaining to a specific invoice during a given period of time. One invoice is typically associated with one case, however, one invoice can be used to bill multiple cases to the same consumer client 20. Examples of bill information include: invoice identification number, beginning date interval of the invoice, ending date interval of the invoice, case number, client number, date, total fees, total expenses and the total dollar figure of the invoice.

In one embodiment of the present invention, the billing data 12 can be stored in a database aspect of the service provider computer system 11. The billing data 12 can be stored in the database by manual read-and-enter process or can be stored as a function of software provided by the service provider 13. In one embodiment, the service provider computer system 11 may comprise a database containing pre-entered standard billing data fields. In another embodiment, the service provider 13 may create billing data fields and enter billing data 12 entries that are not part of the pre-entered standard billing data fields of the service provider computer system 11. Examples of billing data fields the service provider 13 may add or delete include: client information, case information and timekeeper information.

The service provider computer system 11 may further comprise customizable or service provider-defined fields to enter billing data 12 that is not included in the pre-entered standard billing data fields. In another embodiment, the billing hub module 17 may allow the service provider 13 to delete or remove pre-entered standard billing data fields.

In one embodiment of the present invention, Step 40 and Step 42 are performed simultaneously. In another embodiment, Step 42 is performed before Step 40.

At Step 43, service provider application 15 in data communication with service provider computer system 11 electronically accesses the billing data fields stored on the service provider computer system 11. Prior to executing Step 43, service provider application 15 may request permission from the service provider computer system 11 to access the billing data 12 stored thereon. In one embodiment of the present invention, service provider computer system 11 may decline access to the billing data by the service provider application 15 unless certain requirements are satisfied.

At Step 44, service provider application 15 imports a copy of the billing data 12 from the service provider computer system 11. At Step 45, the service provider application 15 arranges each data field from the imported billing data 12 into a pre-existing universal billing format file 16. Each service consumer 20 may impose different billing guidelines 21 on the service provider 13. In order to satisfy the imposed billing guidelines 21, the service provider 13 often has to create and set up service provider-defined fields in the service provider computer system 11. Examples of service provider-defined fields that are sometimes required by service consumers 20 but are not typically included in the standardized billing data 12 field include: adjuster name, agent name, claimant's name, claimant's identification information, claim number, claim office, claim's representative name, claim's representative number, client matter identification number, coverage, date of claim, date of loss, division name, division office, invoice sequence, invoice status, jurisdiction, last bill, line of business, matter reference identification number, insured name, opposing counsel, other clients on the matter, opposing firm, percentage of the bill to be paid, plaintiff attorney, plaintiff name, policy number, state filed, suit indicated, type of loss and the like.

Since service providers 13 have no means for knowing the billing guidelines 21 of potential service consumers 20 until they receive notice of the service consumer's 20 billing guidelines 21, it is impractical to impose restrictions on how each service provider 13 can create specific service provider-defined fields. Accordingly, one service provider 13 may set up their service provider-defined fields differently from a second service provider 13. For example, Service Provider A may use user-defined field X to record the case docket number, whereas Service Provider B may use user-defined field Y to record the case docket number. Service provider application 15 maps the individual billing data field entries imported from the service provider computer system 11 into a standardized universal billing format file 16. Every time a service provider 13 submits an invoice request 14, the service provider application 15 imports billing data 12 from the data fields established for each client, and converts the billing data field entries into a universal billing format file 16 that is structurally identical for every invoice request 14 directed to every service consumer 20. This effectively eliminates the need for the service provider 13 to individually format invoices for each case and for each service consumer 20.

In one embodiment of the present invention, the universal billing format file 16 may comprise a specific order of billing data entries. In another embodiment, the universal billing format file 16 may comprise a specific arrangement of billing data 12 imported from timekeeper information, client information, case information, timecard information, costcard information and bill information stored on the service provider computer system 11. In another embodiment, timecard information and costcard information billing data field entries are the main data repositories from which billing data 12 is imported. In another embodiment, case information, timekeeper information, client information, invoice information and user-defined fields are data repositories from which billing data 12 is imported.

In another embodiment, billing data field entries required for service provider application 15 to generate a universal billing format file 16 include: firm identification tax number, firm name, firm address, firm phone number, firm fax number, client number, client name, client address, invoice number, invoice date, beginning date of invoice, ending date of invoice, invoice discount, invoice total, case number, case description, case type, case arrangement, case contact name, case responsible attorney, case billing address, case open date, case close date, plaintiff's name, timekeepers assigned, timekeeper number, timekeeper initials, timekeeper name, timekeeper title, timekeeper practice area, timekeeper billing rate, date of work performed, hours worked, rate billed, work description, task codes, activity codes, time record value, disbursement date, disbursement quantity, disbursement rate, disbursement code, disbursement record value, disbursement description, total fees, total expenses and total figure of the invoice.

At step 46, the service provider application 15, transmits the universal billing format file 16 by communication means 18 to the billing hub module 17. At step 47, the billing hub module 17 identifies the service consumer 20 that corresponds to the universal billing format file 16 received by the billing hub module 17. At Step 48, the billing hub module 17 retrieves the billing guidelines 21 received from the service consumer 20 corresponding to the universal billing format file 16 received by the billing hub module 17.

In one embodiment of the present invention, Step 46 and Step 41 can occur simultaneously. In another embodiment, Step 41 can occur at any time after Step 40 and before Step 48.

At Step 49, the billing hub module 17 reprocesses the billing data 12 entries contained in the universal billing format file 16 as specified by the billing guidelines 21. At Step 50, the billing hub module 17 converts the reprocessed billing data 12 into a client invoice file 22 that presents the billing data 12 that was originally entered on the service provider computer system 11 in accordance with the format, content and processing billing guidelines 21 submitted to the billing hub module 17 by the service consumer 20. At Step 51, the billing hub module 17 transmits the client invoice 22 file to the service consumer. In one embodiment, the billing hub module 17 transmits the client invoice 22 to the service consumer's computer, computer system or computer network through communication means 18.

At Step 52, the service consumer's 20 computer system transmits a notice status 24 to the billing hub module 17 indicating whether the service consumer 20 has accepted or rejected the client invoice 22. In one embodiment of the present invention, if the service consumer 20 rejects the client invoice 22, the notice status 24 must be accompanied by a reason indicating why the client invoice 22 was rejected. At step 53, the billing hub module 17 writes a log entry recording whether the client invoice 22 was received, accepted and/or rejected by the service consumer. In one embodiment, if the client invoice 22 was rejected and accompanied by a reason indicating why the client invoice 22 was rejected, the billing hub module 17 records the reason for rejection.

When the billing hub module 17 receives a rejected invoice, it runs a check process to determine whether the problem resides with an entry from the service provider 13 or with the universal billing format file 16. If the problem is an error in the universal billing format file, the billing hub module 17 will transmit a request to the service provider application 15 to re-process a new universal billing format file 16 in accordance with the service consumer's 20 billing guidelines 21. In the case of all other rejections, such as the client was charged for services not performed, or a service provider 13 has charged more than previously agreed upon, the rejections will first be sent to the billing hub module 17. The billing hub module 17 will not re-process the universal billing format file 16, instead it will send the file 16 back to the service provider computer system 11 with the appropriate observations made by the service consumer 20. In one embodiment of the present invention, the billing hub module 17 will store these observations in a database for future validation processes and to notify the service provider that the client invoice 22 was rejected. In another embodiment, the rejected reasons may be incorporated into a “smart” software that will use the rejected reasons to aid in the validation process. Every service provider 20 individually will benefit from what the “smart” software learns about the rejection reasons received from each individual service provider 13.

Service consumers 20 may require that every charge included in a client invoice 22 be assigned a code that will facilitate an automated analysis of the charges. The codes typically correspond to the Litigation Code Set or the UTBMS code set as specified by the American Bar Association, although many service consumers 20 have created variations to best their individual business needs. Sample code sets include activity codes, task codes and costs codes. For example, a charge described as “review of new file including claim petition” could be assigned the activity code A104, which indicates the generalized category of “Review and Analysis”, and task code L140, which indicates the generalized category of “Document/File Management”. Similarly, a charge described as “Photocopy of driving permit” could be assigned the cost code E101 which indicated the generalized category of “Photocopy”. In one embodiment of the present invention, the billing hub module 17 records the codes assigned to each charge within each client invoice. These records may be incorporated into a “smart” software that will learn to determine the appropriate task, activity and cost codes to assign to the corresponding entries based on the charge description, thereby eliminating the need for a service provider 13 to code the billing data by hand. In another embodiment, every individual service provider 13 will benefit from what the “smart” software learns about coding invoice entries entered from all service providers 13 combined.

At Step 54, the billing hub module 17 transmits the notice status 24 to the service provider application 15 through communication means 18. In one embodiment of the present invention, the notice status 24 transmitted to the service provider application 15 comprises essentially the same content as the notice status 24 file transmitted to the billing hub module 17 from the service consumer 20. In another embodiment, the billing hub module 17 generates a new notice status 24 file to transmit to the service provider application 15. In another embodiment, if the client invoice 22 was rejected by the service consumer 20, the notice status 24 transmitted from the billing hub module 17 to the service provider application 15 indicates the reason for rejection. In another embodiment, the notice status 24 is transmitted from the service provider application 15 to the service provider computer system 11.

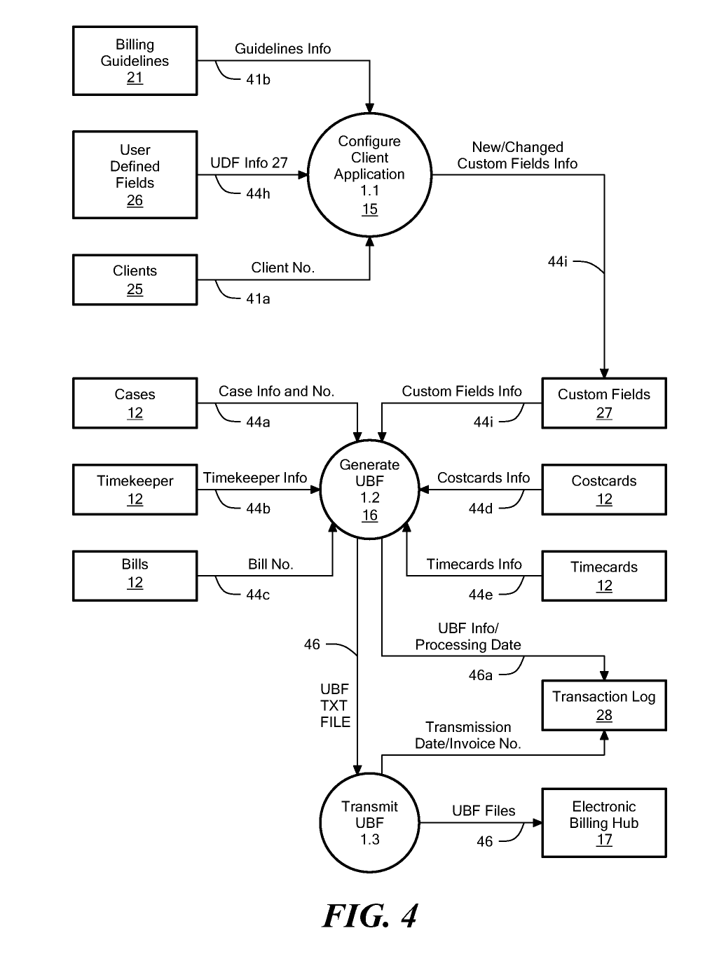

FIG. 4 is a diagram illustrating the processes of system 10 of FIG. 1 executed on the service-provider based applications.

If the universal billing format file 16 does not contain billing data 12 fields that correspond to the billing guidelines 21 supplied by the service consumer 20, the client invoice 22 generated by the billing hub module 17 will most likely be rejected by the service consumer 20. To greatly reduce the number of client invoices 22 that are rejected by the service consumer, the service consumer information number and the billing guidelines 21 supplied by the service consumer to the billing hub module 17 are transmitted to the service provider application 15 through communication means 18.

At Step 41a, a service consumer information number 25 selected to be identifiable to the service provider application 15 as corresponding to specific client billing data 12 within the service provider computer system 11 is transmitted to the service provider application 15 from the billing hub module 17. At Step 41b, billing guidelines 21 corresponding to the specific service consumer 20 are transmitted from the billing hub module 17 to the service provider application 15. In one embodiment of the present invention, Step 41a and Step 41b may occur simultaneously. In another embodiment, Step 41b may occur prior to Step 41a.

At Step 44a, service provider application 15 imports a copy of the case information billing data 12 from the service provider computer system 11. At Step 44b, service provider application 15 imports a copy of the timekeeper information billing data 12 from the service provider computer system 11. At Step 44c, service provider application 15 imports a copy of the bill information billing data 12 from the service provider computer system 11. At Step 44d, service provider application 15 imports a copy of the costcard information billing data 12 from the service provider computer system 11. At Step 44e, service provider application 15 imports a copy of the timecard information billing data 12 from the service provider computer system 11. In one embodiment of the present invention, Steps 44a-e occur simultaneously. In another embodiment, Steps 44a-e can occur in any order.

At Step 44f, the service provider application 15 performs a validation process to validate the billing data 12 by determining if the billing data 12 imported from the service provider computer system 11 through Steps 44a-e, contains sufficient billing data entries to satisfy the billing guidelines 21. In one embodiment of the present invention, Step 44f occurs after Step 45 and before Step 46. If the billing data 12 entries satisfy the billing guidelines 21, service provider application 15 proceeds to arrange each data field from the imported billing data 12 into the pre-existing universal billing format file 16 of Step 45. If the billing data 12 entries do not satisfy the billing guidelines 21, at contingent Step 44g, service provider application 15 requests the service provider 13 to enter additional service provider-defined fields 26. At contingent Step 44h, the service provider 13 enters additional service provider-defined billing field entries 27 into the service provider computer system 11. At contingent Step 44i, service provider application 15 imports a copy of the custom service provider-defined billing data field entries. At contingent Step 44j, the service provider application module 15 re-determines if the billing data 12 and the newly entered user-defined billing data field entries 27 imported from the service provider computer system 11 through Steps 44a-e and Step 44i, contain sufficient billing data 12 entries to satisfy the billing guidelines 21. If the billing data 12 and newly entered user-defined billing data field entries 27 satisfy the billing guidelines 21, service provider application 15 validates the billing data 12 and proceeds to arrange each imported data field entry into the pre-existing universal billing format file 16 of Step 45. If the imported billing data 12 entries do not satisfy the billing guidelines 21, service provider application 15 aborts reporting a failure. In one embodiment, service provider application 15 repeats contingent Steps 44g-j as necessary.

For example, the billing guidelines 21 for a specific service consumer 20 require the service provider 13 to furnish the docket number and the settle amount for a case and these two fields are not part of the standard fields of the case in the service provider computer system 11. The service provider 13 must create two service provider-defined fields for the case, one for the docket number and one for the settle amount. When the service provider 13 submits the invoice request 24, the validation process retrieves the billing guidelines 21 from the billing hub module 17. The validation process recognizes that for this particular service consumer 20, the service provider 13 must supply the fields for docket number and settle amount. The validation process then determines whether these fields are part of the service provider's billing system. If they are not, the validation process reads from customization tables in order to determine the field names in the database associated with the service provider-defined fields. Once the validation process has retrieved from the service provider computer system 11 the values of the appropriate user-defined fields, the validation process determines if the entries had a valid value. In this case, if the docket number and settle amount were entered, the validation process is successful and the universal billing format file 16 will be generated. If no valid value was entered, the validation process aborts and reports a failure. The reporting a failure process may query the service provider to provide a valid value.

In one embodiment of the present invention, at Step 46a the service provider application module 15, records a transaction log 28 in which the information contained in the universal billing format file 16 may be recorded. Examples of information that may be recorded in the transaction log 28 include: transmission date, invoice number, processing date and additional information contained in the universal billing format file. In one embodiment of the present invention, information is recorded in the transaction log 28 after the universal billing format file 16 has been generated but before it is transmitted to the billing hub module 17. In another embodiment, information is recorded in the transaction log 28 and the universal billing format file 16 is transmitted to the billing hub module 17 simultaneously. In another embodiment, information is recorded in the transaction log 28 after the universal billing format file 16 is transmitted to the billing hub module 17.

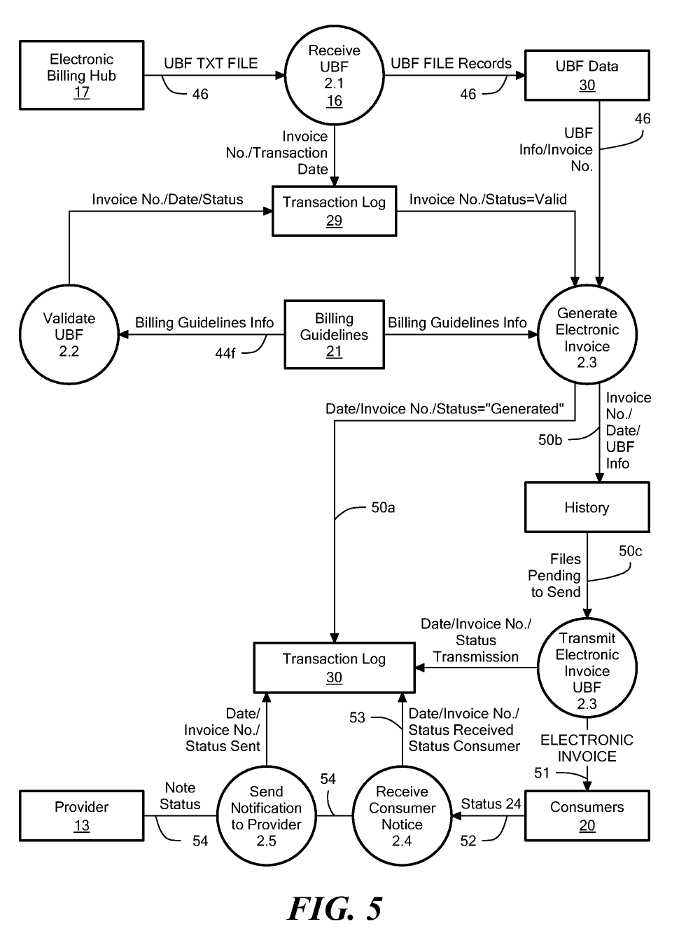

FIG. 5 is a diagram illustrating the processes of system 10 of FIG. 1 executed on the billing hub based applications.

At Step 47a, the billing hub module 17 records a transaction log 29 in which the information contained in the universal billing format file may be recorded. Examples of information that may be recorded in the transaction log 29 include: transmission date, invoice number, processing date and additional information contained in the universal billing format file. In one embodiment of the present invention, information is recorded in the transaction log 29 after the universal billing format file 16 has been received by the billing hub module 17 and before the client invoice 22 has been generated.

At Step 50a, the billing hub application module 17, records a transaction log 30 in which the information contained in the universal billing format file 16 may be recorded. Examples of information that may be recorded in the transaction log 30 at Step 50a include: the invoice number, processing date and generated status information.

In one embodiment of the present invention, at Step 50b an electronic history of generated client invoices 22 may be recorded in the billing hub module 17 or transmitted to an external device, application or system. In another embodiment, a delay application may be present at Step 50c that withholds client invoices 22 from being transmitted to the service consumer 20 until an additional authorization is received from the service provider 13 or other external device, application or system.

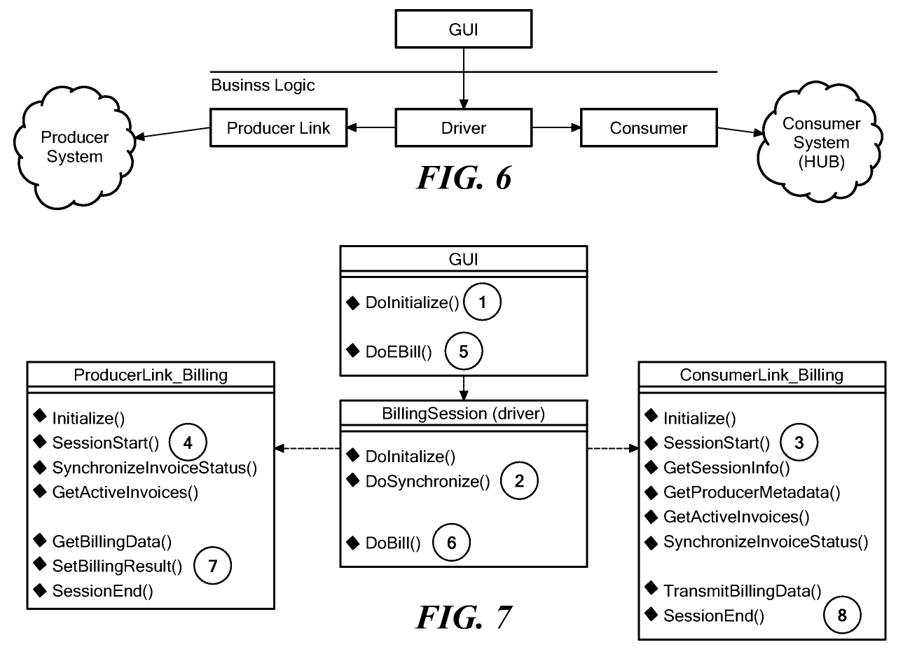

FIG. 6 is diagram illustrating the business logic and incorporating a graphic user interface (GUI) display. In one embodiment of the present invention, a GUI allows a user, such as a service provider user, to interact with the electronic billing system. The GUI 59 interfaces with the driver 60 that encapsulates the billing guidelines 21 and transmits the billing guidelines 21 to the producer link 61, which abstracts the details of the application used to generate the billing data 12 under a common API, and to the consumer link 62, which abstracts the details used to receive billing data 12 under a common API. In one embodiment access may be obtained through an active server page (ASP) web page that receives requests and forwards them to the appropriate server components.

Driver 60 commands the consumer link 62 to obtain necessary information to carry out a billing session. In one embodiment, this information includes the lists of service consumers 20 a particular service provider is allowed to bill, the billing guidelines for the service consumers, and other like information. Part of this information is kept private within the consumer link 62 and part of it is passed to the producer link 61. Driver 60 also obtains the latest invoice status information from the consumer link 62 and passes it to the producer link 61. This information notifies the service provider 13, among other things, what client invoices 22 are being processed by the service consumer 20, which ones have been validated and accepted, which ones have been rejected due to improper information, which ones have been approved for payment and which ones have been paid.

Driver 60 also obtains a list of newly prepared invoices at the service provider's 13 site. This list contains summary information about each new invoice: client name, case name, total amount, due date, and the like. This list is presented to the service provider 13 user, who is then given the ability to select which client invoices 24 the user desires to bill at this time. In another embodiment, driver 60 obtains detailed invoice information for those invoices previously selected in the form of the universal billing format file 16. Driver 60 passes the universal billing format file 16 to the consumer link 61, which validates it against the billing guidelines 21 appropriate for each client invoice 22. The client invoices that pass the validation process will be transmitted to the service consumer, or in this case the billing hub module 17 (HUB). In one embodiment, the GUI will show a validation report showing detailed error information about each of the items within each invoice, allowing the service provider 13 to later correct the errors within the service provider computer system 11.

In one embodiment, a GUI is not necessary for operation of the invention, allowing the client invoices 24 to be automatically sent as soon as they are ready and reviewed.

FIG. 7 is a diagram illustrating the billing protocol.

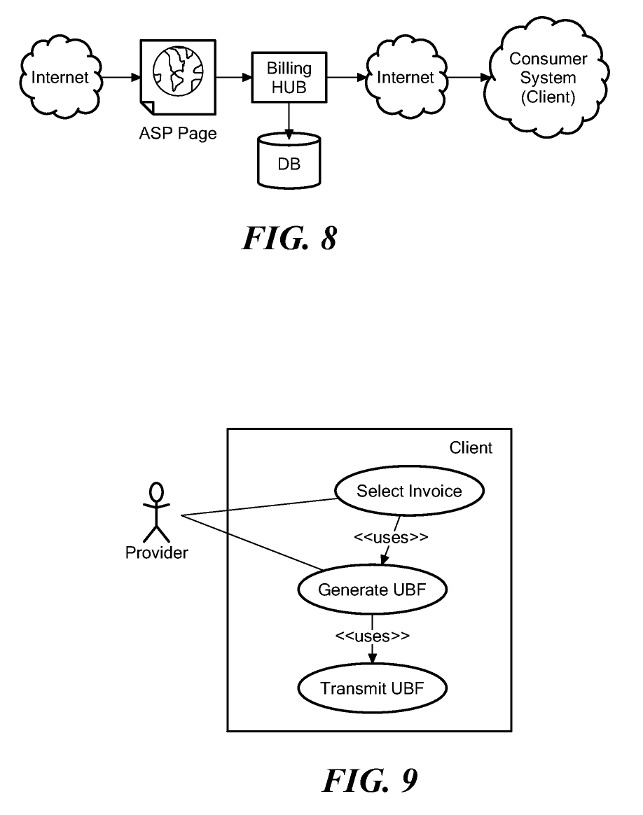

FIG. 8 is a diagram illustrating the billing protocol structure when using an ASP web page. In this arrangement, the system automatically forwards the client invoice 22 to the appropriate consumer. In one embodiment, this can be accomplished by forwarding invoices by email attachment, file transfer protocol (FTP) uploading, and file copying within a virtual private network. Every invoice that is accepted by the service consumer's computer system is marked, such as “ebilled”, so the service provider 13 is notified that they can expect payment. Every invoice that is rejected by the service consumer 20 is sent back to the service provider 13 so that the service producer can amend the billing data 12 and resubmit the invoice for billing.

An example universal billing format file in XML, that can be accessed through a raw invoice data application to help troubleshoot data problems is as follows:

<?xml version=“1.0” encoding=“utf-8”?>
- <UBFDocument classType=“EBH_Utilities.UBF_document”>

- <producer classType=“EBH_Utilities.UBF_producer”>

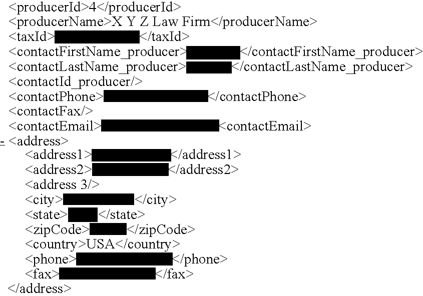

</producer>

- <consumers classType=“EBH_Utilities.MapObject”>

- <item sourceId=“0001504” ClassType=“EBH_Utilities.UBF_consumer”>

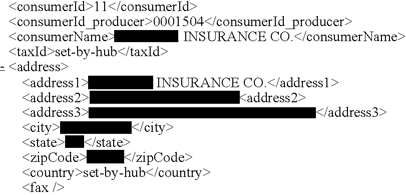

</address>

- <invoices classType=“EBH_Utilities.MapObject”>

- <item classType=“EBH_Utilities.UBF_invoice” sourceId=”9892719>

<invoiceId>1050</invoiceId>
<invoiceId_producer>9892719</invoiceId_producer>
<invoiceDate>2001-01-31T00:00:00</invoiceDate>
<startDate>2000-12-01T00:00:00</startDate>
<endDate>2000-12-08T00:00:00</endDate>
<baseAmount>137.1</baseAmount>
<discountType>None</discountType>
<discountAmount>0</discountAmount>
<discountPercent>0</discountPercent>
<totalNetDue>137.1 </totalNetDue>

-<matters classType=“EBH_Utilities.MapObject”>

- <item sourceId=“0001504.0203889” classType=”EBH_Utilmties.UBF_matter”>

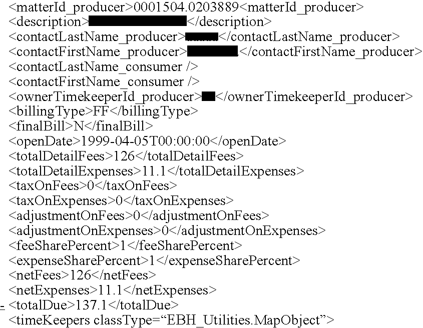

- <item sourceId=“1507”classType=“EBH_Utilities.UBF_timekeeper”>

<timekeeperId_producer>JRW</timekeeperId_producer>

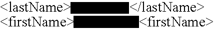

<timekeeperLevel>Associate</timekeeperLevel>
<timekeeperRate>105</timekeeperRate>
<timekeeperHours>1.2 </timekeeperHours>
<timekeeperCost>126</timekeeperCost>

</item>

</timeKeepers>

- <fees classType=“EBH_Utilities.MapObject”>

- <item sourceId=“7500” classType=“EBH_Utilities.UBF_fee“>

<chargeDate>2000-12-08T00:00:00</chargeDate>

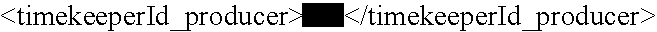

<description>TELEPHONE CONFERENCE WITH THE EMPLOYER

REGARDING LITIGATION STRATEGY</description>

<chargeType>U</chargeType>
<taskCode>L120</taskCode>
<activityCode />
<chargeunits>0.2</chargeUnits>
<chargeRate>105</chargeRate>
<baseAmount>21</baseAmount>
<discountType>None</discountType>
<discountAmount>0</discountAmount>
<discountPercent>0</discountPercent>
<totalAmount>21</totalAmount>
<taxRate>0</taxRate>
<taxOnCharge>0</taxOnCharge>

</item>

- <item sourceId=“7501” classType=“EBH_Utilities.UBF_fee”>

<chargeDate>2000-12-08T00:00:00</chargeDate>

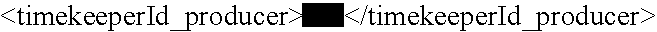

<description>LETTER TO THE CARRIER REGARDING LITIGATION

STRATEGY</description>

<chargeType>U</chargeType>
<taskCode>L120</taskCode>
<activityCode />
<chargeUnits>0.2</chargeUnits>
<chargeRate>105</chargeRate>
<baseAmount>21</baseAmount>
<discountType>None</discountType>
<discountAmount>0</discountAmount>
<discountPercent>0</discountPercent>
<totalAmount>21</totalAmount>
<taxRate>0</taxRate>
<taxOnCharge>0</taxOnCharge>

</item>

- <item sourceId=“7502” classType=“EBH_Utilities.UBF_fee”>

<chargeDate>2000-12-01T00:00:00</chargeDate>
<timekeeperId_producer>JRW</timekeeperId_producer>
<description>REVIEW CLAIMANT'S PERSONNEL FILE</description>
<chargeType>U</chargeType>
<taskCode>L120</taskCode>
<activityCode />
<chargeUnits>0.5</chargeUnits>
<chargeRate>105</chargeRate>
<baseAmount>52.5</baseAmount>
<discountType>Nonec/discountType>
<discountAmount>0</discountAmount>
<discountPercent>0</discountPercent>
<totalAmount>52.5</totalAmount>
<taxRate>0</taxRate>
<taxOnCharge>0</taxOnCharge>

</item>

- <item sourceId=“7503” classType=“EBH_Utilities.UBF_fee”>

<chargeDate>2000-12-01T00:00:00</chargeDate>

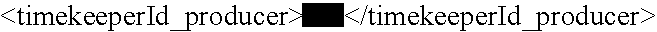

<description>PREPARATION OF CORRESPONDENCE TO CLAIMANT'S

COUNSEL REGARDING CLAIMANT'S PERSONNEL FILE</description>

<chargeType>U</chargeType>
<taskCode>L120</taskCode>
<activityCode/>
<chargeUnits>0.2</chargeUnits>
<chargeRate>105</chargeRate>
<baseAmount>21</baseAmount>
<discountType>None</discountType>
<discountAmount>0</discountAmount>
<discountpercent>0</discountPercent>
<totalAmount>21</totalAmount>
<taxRate>0</taxRate>
<taxOnCharge>0</taxOnCharge>

</item>

- <item sourceId=“7504” classType=“EBH_Utilities.UBF_fee”>

<chargeDate>2000-12-01T00:00:00</chargeDate>

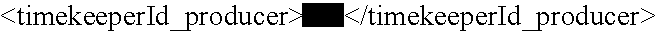

<description>PREPARATION OF CORRESPONDENCE TO THE EMPLOYER

REGARDING CLAIMANT'S PERSONNEL FILE</description>

<chargeType>U</chargeType>
<taskCode>L120</taskCode>
<activityCode />
<chargeUnits>0.1</chargeUnits>
<chargeRate>105</chargeRate>
<baseAmount>10.5</baseAmount>
<discounType>None</discountType>
<discountAmount>0</discountAmount>
<discountPercent>0</dtscountPercent>
<totalAmount>10.5</totalAmount>
<taxRate>0</taxRate>
<taxOnCharge>0</taxOnCharge>

</item>

</fees>

- <expenses classType=“EBH_Utilities.MapObject”>

- <item sourceId=“1647” classType=“EBH_Utitities.UBF_expense”>

<chargeDate>2000-12-05T00:00:00</chargeDate>

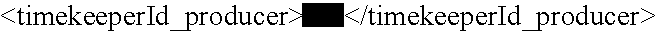

<description />
<chargeType>U</chargeType>
<expenseCode>E101</expenseCode>
<chargeUnits>28</chargeUnits>
<chargeRate>0.1</chargeRate>
<baseAmount>2.8</baseAmount>
<discountType>None</discountType>
<discountAmount>0</discountAmount>
<discountPercent>0</discountPercent>
<totalAmount>2.8</totalAmount>
<taxRate>0</taxRate>
<taxOnCharge>0</taxOnCharge>

</item>

- <item sourceId=“1648” classType=“EBH_Utilities.UBF_expense”>

<chargeDate>2000-12-06T00:00:00</chargeDate>

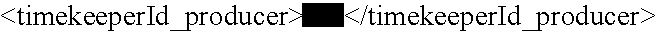

<description />
<chargeType>U</chargeType>
<expenseCode>E101</expenseCode>
<chargeUnits>83</chargeUnits>
<chargeRate>0.1</chargeRate>
<baseAmount>8.3</baseAmount>
<discountType>None</discountType>
<discountAmount>0</discountAmount>
<discountpercent>0</discountPercent>
<totalAmount>8.3</totalAmount>
<taxRate>0</taxRate>
<taxOnCharge>0</taxOnCharge>

</item>

</expenses>

- <HUB_simpleData classType=“EBH_Utilities.Map”>

<item sourceId=“ClaimRepName” targetId=“N/A” />
<item sourceId=“MatterReferenceId” targetId=“N/A”/>

</HUB_simpleData>

</item>

</matters>

- <HUB_simpleData classType=“EBH_Utilities.Map”>

<item sourceId=“postedStatus” targetId=“posted” />

</HUB_simpleData>

- <HUB_objectData classType=“EBH_Utilities.MapObject”>

- <item sourceId=“EBH_Utilities.InvoiceStatuslnfo”

classType=“EBH_Utilities.InvoiceStatuslnfo”>
<invoiceId>1044</invoiceId>
<invoiceId_producer>9892719</invoiceId_producer>
<consumerId_producer>0001504</consumerId_producer>
<statusDateTime>2002-03-13T18:23:05</statusDateTime>
<status>received</status>

- <extraInfo classType=“EBH_Utilities.Map”>

<item sourceId=“postedStatus” targetId=“posted” />

</extrainfo>

</item>

</HUB_objectData>

</item>

</invoices>

</item>

</consumers>

</UBFDocument>

An example XLS stylesheet that when applied to a universal billing format file yields a new file in a predefined LEDES electronic format is as follows:

<?xml version=“1.0”48 >

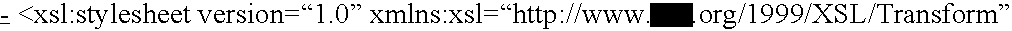

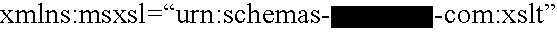

xmlns:user=“http://mycompany.com/mynamespace>
<xsl:output method=“text”/>
<xsl:param name=“theInvoice” />

- <xsl:template match=“/”>

<xsl:copy>LEDES1998B[ ]</xsl:copy>

<xsl:copy>INVOICE_DATE|INVOICE_NUMBER|CLIENT_ID|LAW_FIRM_{—}
MATTER_ID|INVOICE_TOTAL|BILLING_START_DATE_BILLING_END_DATE |
INVOICE_DESCRIPTION|LINE_ITEM_NUMBER|EXP/FEE/INV_ADJ_TYPE|
LINE_ITEM_NUMBER_OF_UNITS|LINE_ITEM_ADJUSTMENT_AMOUNT|
LINE_ITEM_TOTAL|LINE_ITEM_DATE|LINE_ITEM_TASK_CODE|LINE_{—}
ITEM_EXPENSE_CODE|LINE_ITEM_ACTIVITY_CODE|TIMEKEEPER_ID|LINE_{—}
ITEM_DESCRIPTION|LAW_FIRM_ID|LINE_ITEM_UNIT_COST|ITIMEKEEPER_{—}
NAME|TIMEKEEPER_CLASSIFICATION|CLIENT_MATTER_ID [ ]</xsl:copy>

- <xsl:for-each

select=“UBFDocument/consumers/item/invoices/item[invoiceId_{—}
producer=$theInvoice]/matters/item/fees/item |
UBFDocument/consumers/item/invoices/item[invoiceId_producer=$th
eInvoice]/matters/item/expenses/item”>

- <xsl:variable name=“invoiceDate”>

<xsl:value-of select=“../../../../invoiceDate” />

</xsl:variable>

| | |
|---|---|
| - <xsl:copy> | <xsl:value-of select=“user:formatD(string($invoiceDate))” /> |

| | |
|---|---|
| \| | </xsl:copy> |

| | |
|---|---|
| - <xsl:copy> | <xsl:value-of select=“../../../../invoiceId_producer” /> \| |

</xsl:copy>

| | |
|---|---|
| - <xsl:copy> | <xsl:value-of select=“../../../../../../consumerId_producer”/> |

| | |
|---|---|
| \| | </xsl:copy> |

| | |
|---|---|
| - <xsl:copy> | <xsl:value-of select=“../../matterId_producer” /> |

| | |
|---|---|
| \| | </xsl:copy> |

| | |
|---|---|
| - <xsl:copy> | <xsl:value-of select=“../../../../baseAmount” /> |

| | |
|---|---|
| \| | </xsl:copy> |

- <xsl:variable name=“startDate”>

<xsl:value-of select=../../../../startDate” />

</xsl:variable>

- <xsl:variable name=“endDate”>

<xsl:value-of select=“../../../../endDate” />

</xsl:variable>

| | |
|---|---|
| - <xsl:copy> | <xsl:value-of select=“user:formatD(string($startDate))” /> |

| | |
|---|---|
| \| | </xsl:copy> |

| | |
|---|---|
| - <xsl:copy> | <xsl:value-of select=“user:formatD(string($endDate))” /> |

| | |
|---|---|
| \| | </xsl:copy> |

<xsl:copy>|</xsl:copy>

| | |
|---|---|
| - <xsl:copy> | <xsl:value-of select=“position( )” /> |

| | |
|---|---|
| \| | </xsl:copy> |

- <xsl:choose>

- <xsl:when test=“name(..) =‘fees’” />

- <xsl:choose>

- <xsl:when test=“totalAmount>= 0”>

<xsl:copy>F|</xsl:copy>

</xsl:when>

- <xsl:otherwise>

<xsl:copy>IF|</xsl:copy>

</xsl:otherwise>

</xsl:choose>

</xsl:when>

- <xsl:otherwise>

- <xsl:choose>

- <xsl:when test=“totalAmount >= 0”>

<xsl:copy>E|</xsl:copy>

</xsl:when>

- <xsl:otherwise>

<xsl:copy>IE|</xsl:copy>

</xsl:otherwise>

</xsl:choose>

</xsl:otherwise>

</xsl:choose>

| | |
|---|---|
| - <xsl:copy> | <xsl:value-of select=“format-number(chargeUnits,‘#.00’)” /> |

| | |
|---|---|
| \| | </xst:copy> |

- <xsl:choose>

- <xsl:when test=“discount_amount> 0”>

- <xsl:copy> <xsl:value-of select=“discountAmount” />

| | |
|---|---|
| \| | </xsl:copy> |

</xsl:when>

- <xsl:when test=“discountPercent > 0”>

- <xsl:copy>

| <xsl:value-of select=“format-number( (discountPercent | |
|---|---|
| | div 100 ) * baseAmount, ‘#.00’)” /> |
| \| | </xsl:copy> |

</xsl:when>

- <xsl:otherwise>

<xsl:copy>0.00|</xsl:copy>

</xsl:otherwise>

</xsl:choose>

| | |
|---|---|
| - <xsl:copy> | <xsl:value-of select=“format-number(totalAmount, ‘#.00’)” /> |

| | |
|---|---|
| \| | </xsl:copy> |

- <xsl:variable name=“chargeDate”>

- <xsl:copy> <xsl:value-of select=“chargeDate” />

</xsl:copy>

</xsl:variable>

| | |
|---|---|
| - <xsl:copy> | <xsl:value-of select=“user:formatD(string($chargeDate))” /> |

| | |
|---|---|
| \| | </xsl:copy> |

| | |
|---|---|
| - <xsl:copy> | <xsl:value-of select=“taskCode” /> |

| | |
|---|---|
| \| | </xsl:copy> |

| | |
|---|---|
| - <xsl:copy> | <xsl:value-of select=“expenseCode” /> |

| | |
|---|---|
| \| | </xsl:copy> |

| | |
|---|---|
| - <xsl:copy> | <xsl:value-of select=“activityCode” /> |

| | |
|---|---|
| \| | </xsl:copy> |

- <xsl:choose>

- <xsl:when test=“name(..) =‘fees’”>

- <xsl:copy>

<xsl: value-of select=“timekeeperId_producer” />
|

</xsl:copy>

</xsl:when>

- <xsl:otherwise>

<xsl:copy>|</xsl:copy>

</xsl:otherwise>

</xsl:choose>

| | |
|---|---|
| - <xsl:copy> | <xsl:value-of select=“description” /> |

| | |
|---|---|
| \| | </xsl:copy> |

| | |
|---|---|
| - <xsl:copy> | <xsl:value-of select=“/ledesxml/firm/If_tax_id” /> |

</xsl:copy>

| | |
|---|---|
| - <xsl:copy> | <xsl:value-of select=“format-number(chargeRate,‘#.00’)” /> |

| | |
|---|---|
| \| | </xsl:copy> |

<xsl:copy>|</xsl:copy>
<xsl:copy>|</xsl:copy>

- <xsl:copy>

<xsl:value-of select=“normalize-

space(../../HUB_simpleData/item[@sourceId=‘ClaimNumber’]/
@targetId).” />

[ ]

</xsl:copy>

- <xsl:copy>

<xsl:value-of select=“user:newLine( )” />

</xsl:copy>

</xsl:for-each>

</xsl:template>

</xsl:stylesheet>

An example formatted representation of the universal billing format XML file using the LEDES format is as follows:

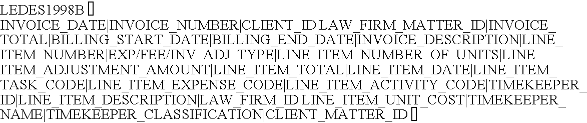

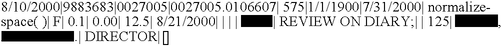

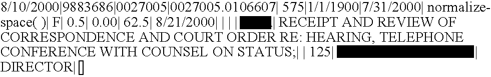

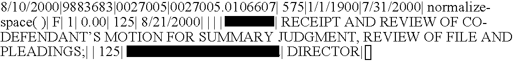

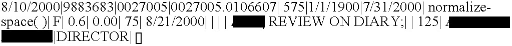

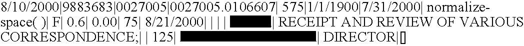

FIG. 9 is a diagram illustrating a sample use-case diagram for the client sub-system.

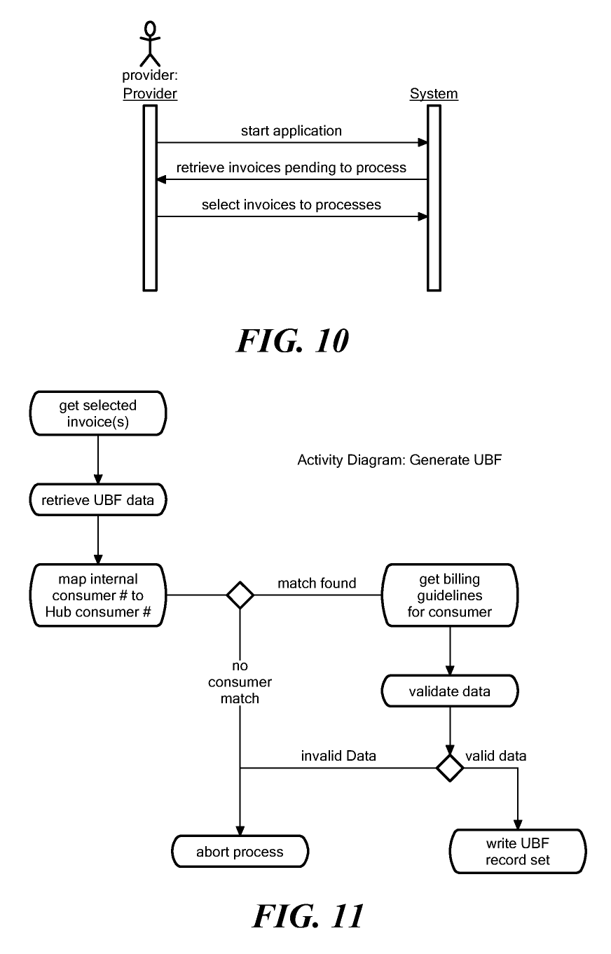

FIG. 10 is a diagram illustrating the select invoice feature of the use-case. The service provider 13 initiates the service provider application 15 in order to select the invoices to process. The system presents to the service provider user a list of invoices pending to be sent to the service consumer 20. The system has an option to display the already sent invoices in case an invoice re-transmission is needed.

FIG. 11 is a diagram illustrating the generate universal billing format file feature of the use-case. Once the service provider user has selected the invoice(s) to process, the system retrieves the billing data 12 from different tables in the database that correspond to the selected invoice number(s). Every service provider assigns a specific consumer identification number to the service consumers 20 managed by the service provider application 15. The service provider application 15 maps the service provider's 13 internal consumer identification number to a generic number. For Example, Service Provider A has assigned Client X to number 0001 and Service Provider B has assigned Client X to number 1500. The service provider application 15, maintains a cross-reference for each service provider it manages. After the service consumer number has been determined, the billing guidelines 21 for that service consumer 20 are retrieved for validation purposes. If errors are found during the validation process, the validation process aborts. If no errors are found during the validation process, the universal billing format file is generated. Optionally, the generated universal billing format file 16 can be stored in a specified directory.

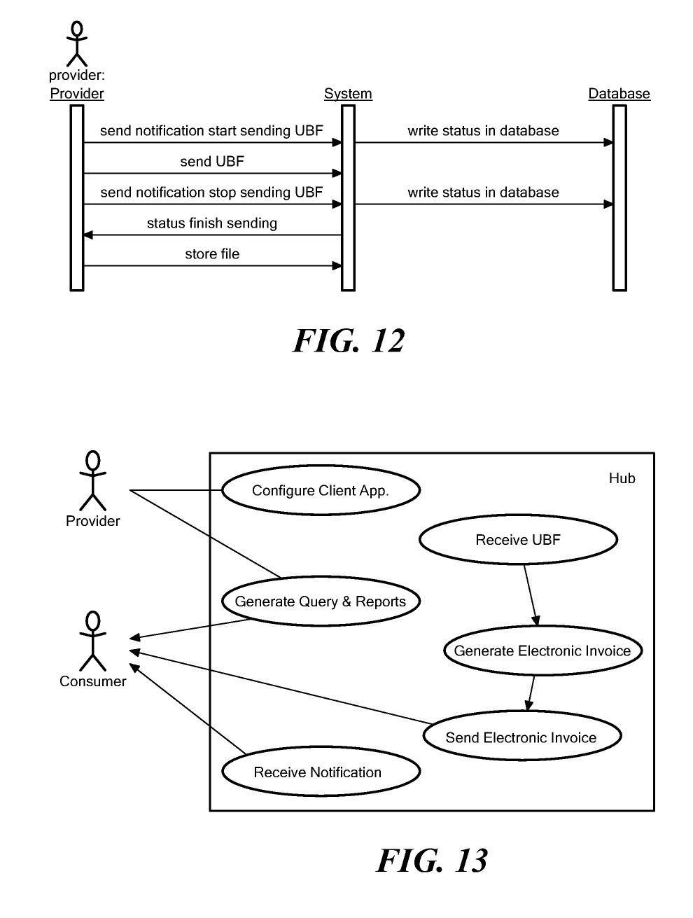

FIG. 12 is a diagram illustrating the transmittal of the universal billing format file feature of the use-case. The universal billing format file 16 is sent to the billing hub module 17 by an interface in the service provider application 15. A log trace is recorded before and after transmission.

FIG. 13 is a diagram illustrating the diagrams billing hub module subsystem feature of the use-case.

Once the universal billing format file is sent to the billing hub module 17, a transaction log is recorded.

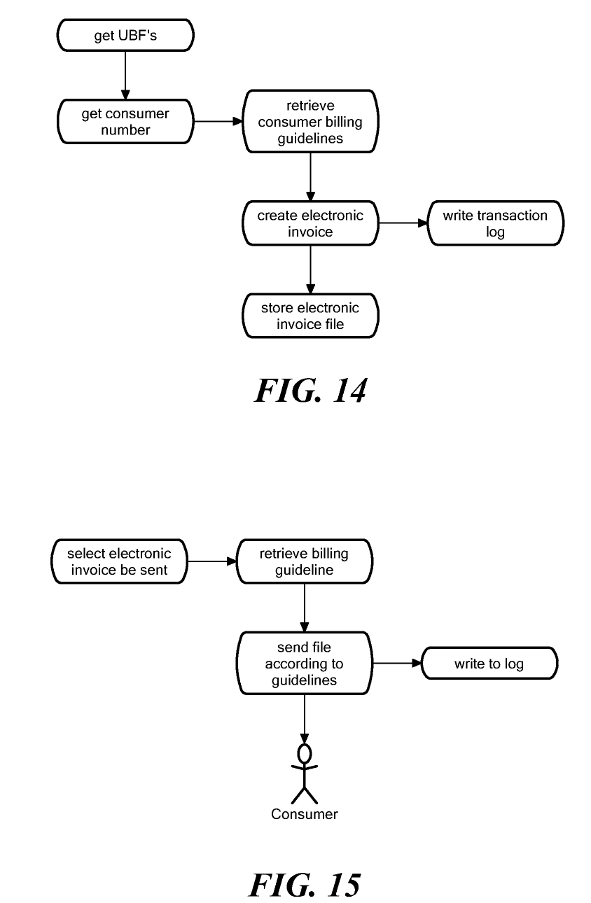

FIG. 14 is a diagram illustrating the generate electronic invoice feature of the use-case. A server running in the billing hub module 17 processes the universal billing format files as they arrive in the billing hub module 17 in order to generate an electronic invoice in compliance with the service consumer's billing guidelines 21. Since the service consumer identification number is stored in the universal billing format file 16, the billing format specifications for the specific service consumer number are retrieved from the billing hub module's 17 database. The electronic invoice is created and formatted in compliance with the service consumer's billing guidelines 21. Once the generation process is complete, a transaction log is recorded indicating the status of the process.

FIG. 15 is a diagram illustrating the send electronic invoice feature of the use-case. Once the electronic client invoice 22 is created, it needs to be sent to the service consumer 20. Since each service consumer 20 has different mechanisms for sending invoices, this process is partially automated. The billing hub module 17 reads from the specific billing guidelines 21 the appropriate mechanisms for sending invoices. For those service consumers 20 that require the client invoice 22 to be sent by an e-mail file or uploading it onto a website, or copied through a virtual private network, the billing hub module 17 automated processes send the client invoice 22 to the service consumer 20. For those service consumers 20 that require the client invoice 22 to be sent by diskette through the mail or whose in house systems are not yet capable of automatically receiving electronic invoices from the billing hub module 17, assigned personnel are responsible for sending the client invoice to the service consumer.

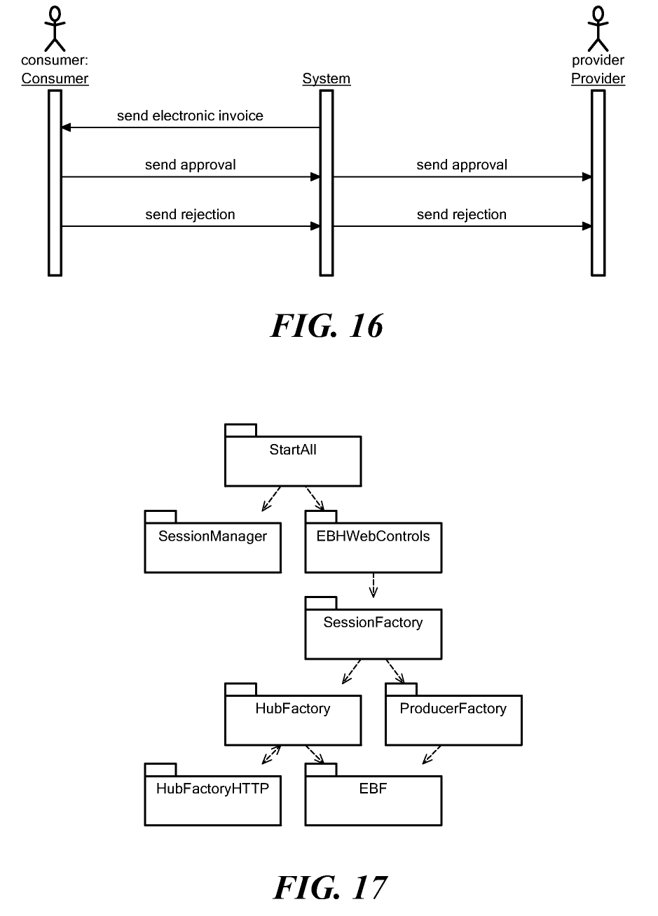

FIG. 16 is a diagram illustrating the receive notification feature of the use-case. The billing hub module's 17 automated process reads e-mail notifications, file uploading results, or other similar communications from the service consumer and logs the information into the database. Notifications that are received through alternate means may require assigned personnel to update the received notice status in the database. After the notification status is stored in the database, the billing hub module's 17 automated process optionally sends notifications through e-mail or other means to the service providers 13 letting them know the service consumer 20 has received, accepted or rejected the client invoice. In the case of a rejection, the reason for rejection is also established.

Service providers 13 can also customize the service provider application 15. Service providers 13 can define a specific set of service consumers to work with, relate internal consumer numbers to electronic billing hub consumer numbers, and map internal service provider-defined fields to fields in the service consumer's billing guidelines 21. This information is maintained in tables stored in the billing hub module's 17 database. Alternatively, this information may be stored in a service provider computer system database.

The billing hub module 17 may optionally furnish service providers 13 and service consumers 20 with reports. Reports generated for service providers 13 may include: invoice status, periodical activity, service consumer statistics, rejected invoices, approved invoices and billings per service consumer per given period. Reports generated for service consumers 20 may include: periodical activity, invoice profile, invoice summary using ABA codes and provider statistics.

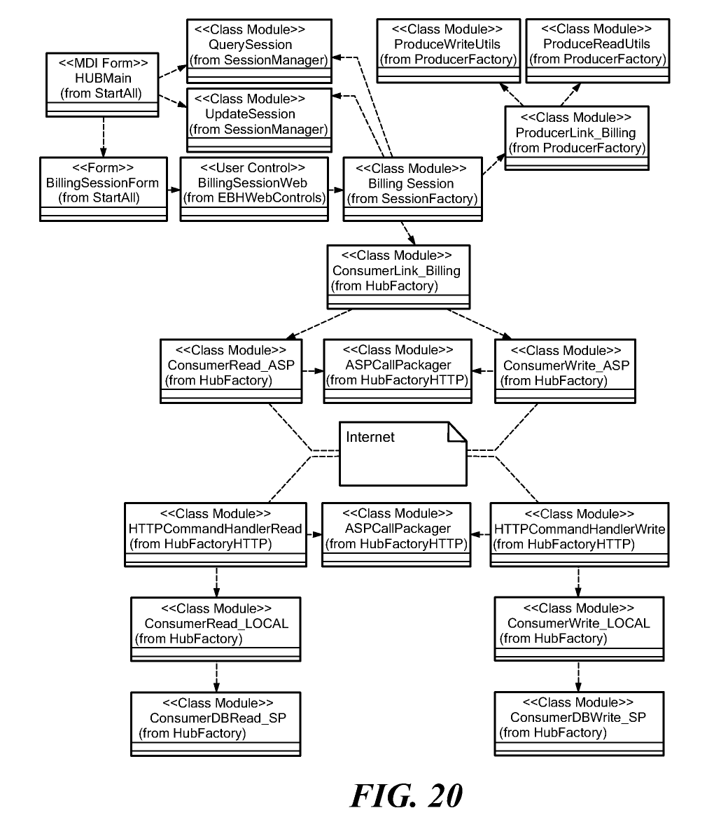

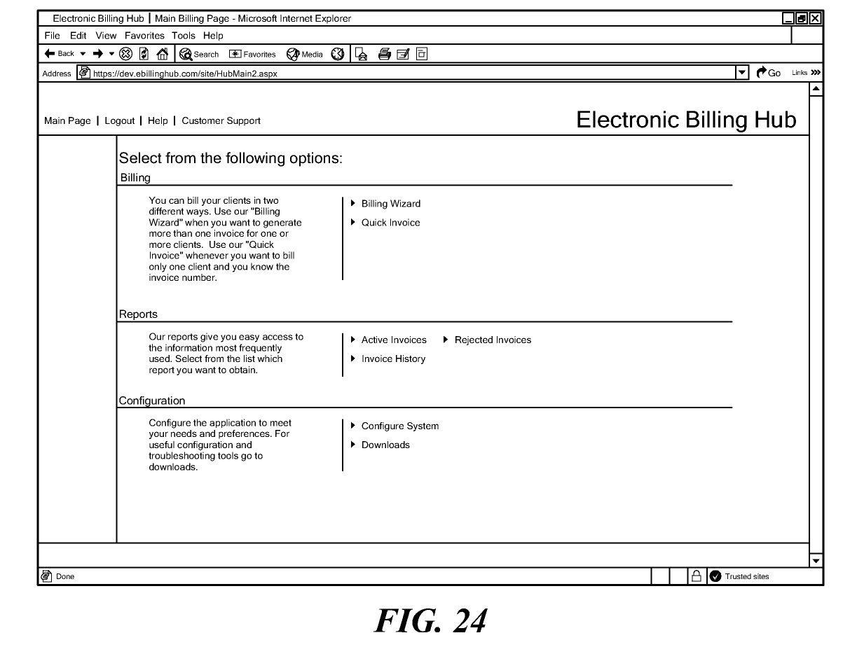

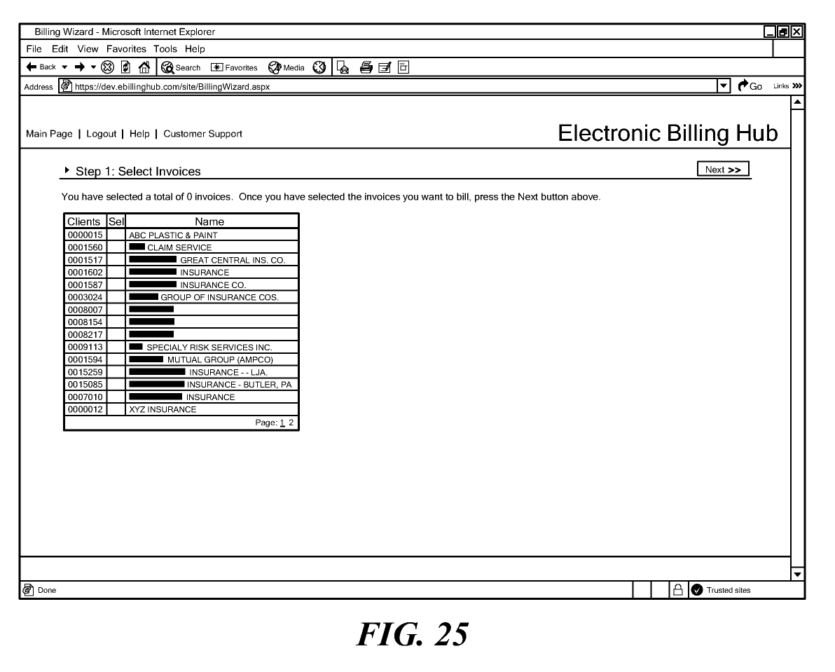

FIGS. 17-22 illustrate class diagrams in which a particular design of the software components of the present invention is demonstrated. Although FIGS. 20-25 illustrate one embodiment of the present invention, multiple variations of the design will achieve the same desired benefits, as will be evident to those skilled in the art.

FIG. 17 is a diagram illustrating the class diagram system overview. StartAll is a representation of other components, emulating a web page requested by the user. In one embodiment, the StartAll represents the “main” function for a C or Java application. The SessionManager package handles the application security by allowing the creation and destruction of managing sessions. A managing session is created whenever a user authenticates with the HUB. The client side of the application then receives a managing session identifier that will be used to authorize and log all actions. The HUB will not accept any request from a client that does not provide a valid managing session identifier. The EBHWebControls package encapsulates the user interface. It is composed of a set of graphical components that will let the user interact with the application. In the standard implementation, each of these controls will be embedded on a wed page that the user will be allowed to request after the user has been authenticated, i.e. logged in.

The SessionFactory package offers the implementation of both billing and configuration sessions. The protocols implemented by these sessions are interactions between the HUB and the service provider's computer system. Every session object creates and initializes both ends of the connection. For security reasons, the ends of the connection cannot be created except indirectly by using a session object, which will not allow the connection unless the user has been properly authenticated.

The HubFactory package encapsulates the access to the HUB. It provides several classes that allow and facilitate access for both reading and writing to the HUB. For example, it provides a function that returns the current status of the invoices in the HUB. The client application can then act on this information. The ProducerFactory package, encapsulates the access to the producer's system. It provides several classes that allow and facilitate access for both reading and writing. For example, it provides a function that returns the list of those invoices inside the producer's billing system that are new and ready to be billed electronically.

The HubFactoryHTTP package, presents the same objects as the HubFactory package but their interfaces are exposed through HTTP protocol. Alternatively, the HUBFactory package can be exposed through SOAP or other similar RPC methods. This allows for the deployment of the application in client-server mode, as opposed to deploying the entire application on a single machine.

The EBF package, encapsulates the universal billing format. It contains several classes that mimic the universal billing format structure and hide the XML representation of the universal billing format from the user. The user can fill in the billing information using regular objects and regular variables, such as strings, and then serialize the document into XML. The EBF Package also provides the user with different external representations of the universal billing format. For example, the EBF Package contains objects and variables that mimic the structure of the LEDES 2000 format.

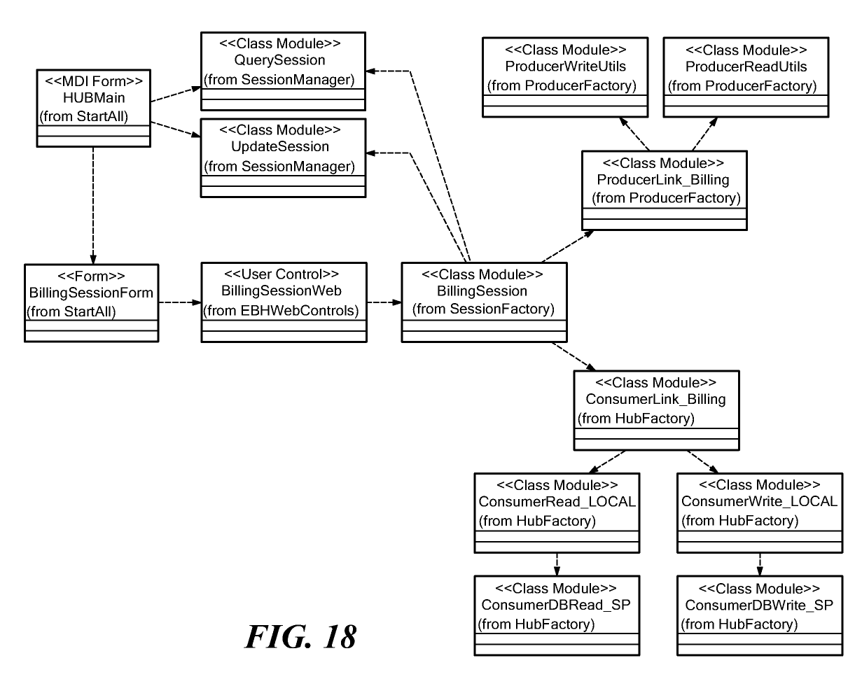

FIG. 18 is a diagram illustrating the class diagram of the run-time configuration of the system when the user is running a billing session. HubMain is the main entry point for the application. It first authenticates the user and, if successful, offers the user the ability of starting both bill and configuration sessions. BillingSessionWeb is a component that offers graphical user interface for a billing session. The component does not contain any business logic and delegates processes to the BillingSession object. BillingSessionWeb performs the functions of creating and initializing a billing session, presenting the user with a list of invoices ready to be billed and letting the user pick which invoices to send and sending the selected invoices to the billing session object for further processing.

BillingSession contains the business logic for the billing process. After authenticating the user, it creates and initializes both ends of the connection between the ProducerLink_Billing and ConsumerLink_Billing and carries out the billing protocol. The billing protocol comprises: synchronizing the invoice status, accepting a list of invoices that the user wants to bill, allowing the producer to obtain billing information about those invoices and passing the obtained billing information to the consumer (in this case the HUB acts as the service consumer). The ProducerLink_Billing class, hides the implementation details of the producer's system. It knows how to access the producer's system and respond to the requests it gets from the BillingSession object. For example, it responds to calls such as: Get Invoice Information (forTheseInvoices as list) as UBF. This method accepts a list of invoices and returns the data arranged in the universal billing format file with detailed billing information about those invoices.

The ConsumerLink_Billing class hides the implementation details of the consumer's system, which in this case is the HUB. It knows how to access the HUB and respond to the requests it gets from the BillingSession object. It responds, for example to calls like: TransmitBillingData (theInvoices as UBF) as string, which transmits to the HUB the billing data arranged according to the universal billing format.

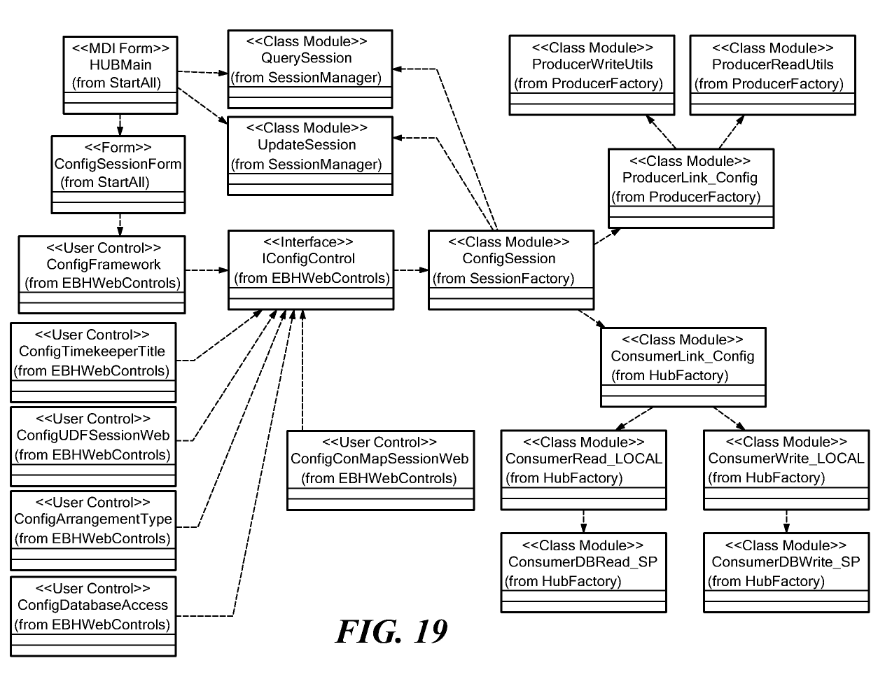

FIG. 19 is a diagram illustrating the run-time configuration of the system when the user is running a configuration session. The run-time configuration is similar to the configuration of the system during a billing session with a few variations. The IconfigControl component defines an interface that is implemented by every configuration component. Examples of configuration controls implemented include: ConfigTimeKeeperTitle which is used to map timekeeper titles, such as partner, paralegal, etc., from the producer's nomenclature to HUB's nomenclature; ConfigArrangementTypes which is used by the user to map matter arrangement types, such as fixed fee, deposition, contingency, etc., from the producer's nomenclature to HUB's nomenclature; ConfigDatabaseAccess which is used by the user to specify the connection settings that will allow the client application to access the required information within the producer's system; and ConfigConMapSessionWeb which is used by the producer to may each of its consumers to the appropriate consumer as defined in the HUB. The user may map the user's internal identification to the HUB identification. The HUB has the knowledge required to translate from HUB's nomenclature to the nomenclature required by each particular service consumer.

The ConfigSession contains the business logic for the configuration process. The ConfigSession component creates and initializes both ends of the connection (ProducerLink_Config and ConsumerLink_Config) and carries out the configuration protocol. After initialization the only two commands this class accepts are an update command, used if the user has modified any aspect of the configuration and wants the changes to be saves, and a cancel command, used if the user does not wish any changes to be saved. The ConfigSession class hides the interface of both the producer and the consumer to force the protocol to be followed.

FIG. 20 is a diagram illustrating the run-time configuration of the system when the user is running a billing session and the HUB is deployed to be used through the Internet. Features that are different from the case in which the HUB has been deployed to work locally include: the ConsumerLink_Billing; the ConsumerRead_ASP and ConsumerWrite_ASP; the HTTPCommandHandlerRead; HTTPCommandHandlerWrite and ASPCallPackager.

The ConsumerLink_Billing class hides the implementation details of the consumer's system. The class can access the HUB and respond to requests from the BillingSession object. For example, it can respond to calls like: TransmitBillingData (theInvoices as UBF) as string. This method accepts a universal billing format containing detailed billing information and returns a string with the error status. The billing data will be transmitted to the HUB.

The ConsumerRead_ASP and ConsumerWrite_ASP objects both implement the same interface as their local counterparts, but the actual implementation includes a “service” running on a server reachable from the client computer through HTTP, SOAP, or other similar Remote Procedure Call (RPC) mechanism. These classes are able to issue calls to that service and return the results to the calling ConsumerLink_Billing object. ConsumerRead_ASP and ConsumerWrite_ASP function as the proxies of real ConsumerRead_LOCAL and ConsumerWrite_LOCAL while HTTPCommandHandlerRead and HTTPCommandHandlerWrite work like the stubs of those same components. The proxies function to store every call received as an XML file, encrypt it and then use HTTP POST command to send it to the Internet server. The server then returns the request using another XML document that contains the results of the function call. The proxies decrypt and unpack the response and return t to the caller.

The HTTPCommandHandlerRead and HTTPCommandHandlerWrite objects work as the “stubs” of the real ConsumerRead_LOCAL and ConsumerWrite_LOCAL. An Internet server receives an HTTP POST command requesting a specific Active Server Page, which contains a script code. The script code creates an instance of the appropriate “stub” component and forward the HTTP POST request to it. The stub then extracts the posted data from the request, decrypts it, and unpacks the information required about the function call the client wishes to perform. The stub then creates an instance of ConsumerRead_LOCAL, and issues the function call to the component. It then re-packs the result back into an XML file, encrypts it, and returns it to the client as a ‘regular’ HTTP response.

The ASPCallPackage class has the utility functions to pack and unpack function calls and function call parameters such as an XML file. It also offers functions to encrypt and decrypt data.

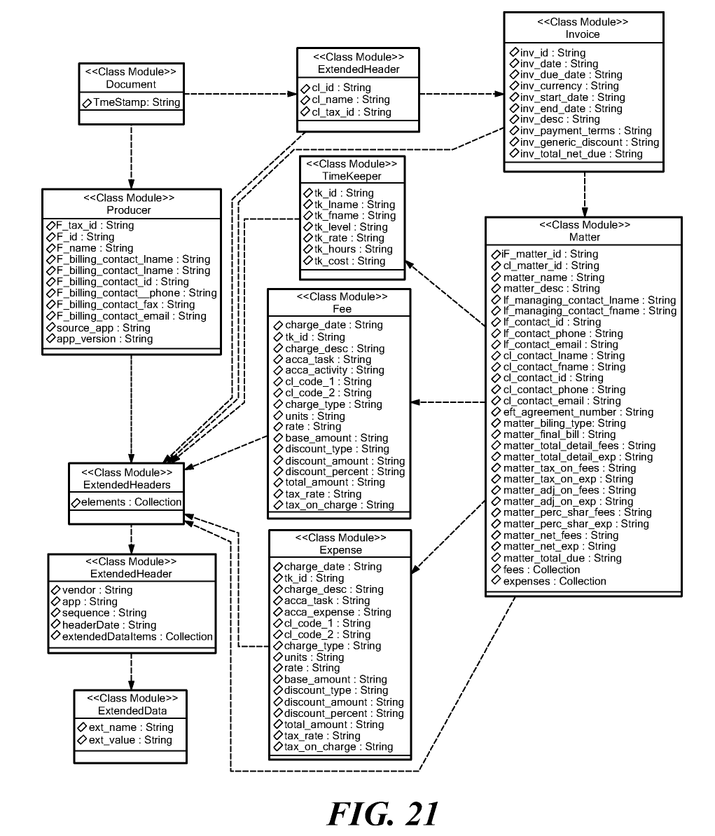

FIG. 21 is a diagram illustrating the class diagram for the components that facilitate creating a universal billing format file for the LEDES 2000 standard.

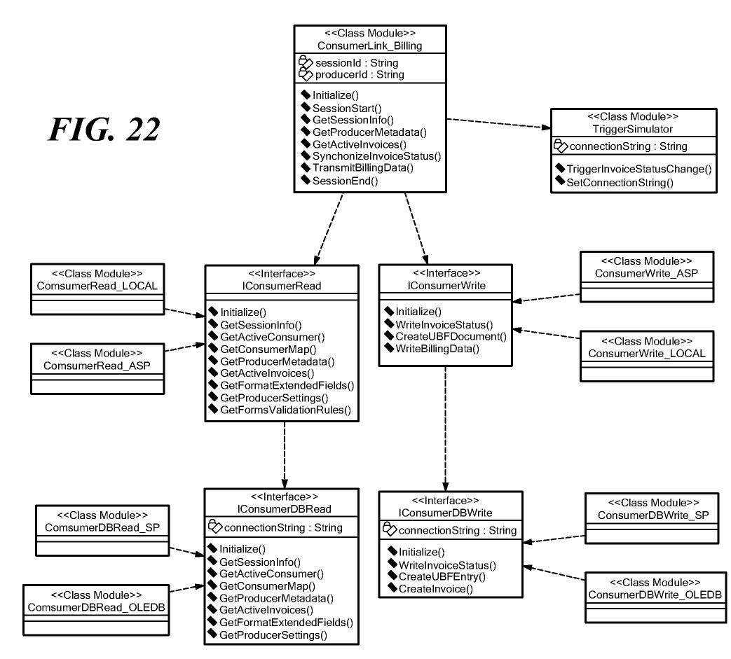

FIG. 22 is a diagram illustrating the class diagram for the hub link. IConsumerRead and IConsumerWrite define two interfaces that instances of ConsumerLink_Billing will invoke. The HUB can be deployed in LOCAL mode or in ASP mode. These two modes are supported by two different implementations of these interfaces: ConsumerRead_LOCAL and ConsumerRead_ASP. The LOCAL implementations will access the database storage directly while the ASP implementations will access the database through an HTTP server on the Internet.

Similarly, IConsumerDBRead and IConsumerDBWrite define two interfaces that abstract the retrieval of record sets from the database. In one implementation ConsumerDBRead_SP retrieves record sets from the database by invoking stored procedures. This implementation is more commonly used when the HUB is deployed in ASP mode because the organization running the Internet server has exact knowledge of the database being used and can write stored procedures in its specific language. In another embodiment, ConsumerDBRead_OLEDB retrieves record sets from the database by composing a query at runtime and sending it to the database. This implementation is more commonly used when the HUB is deployed in LOCAL mode, because in this case each organization may have a different database system, making it difficult to create stored procedures designed for them.

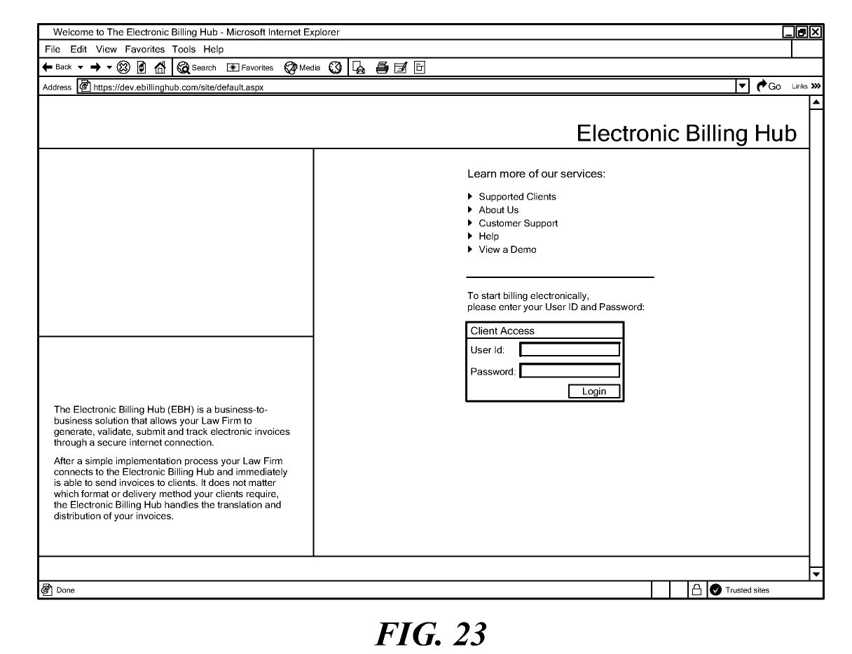

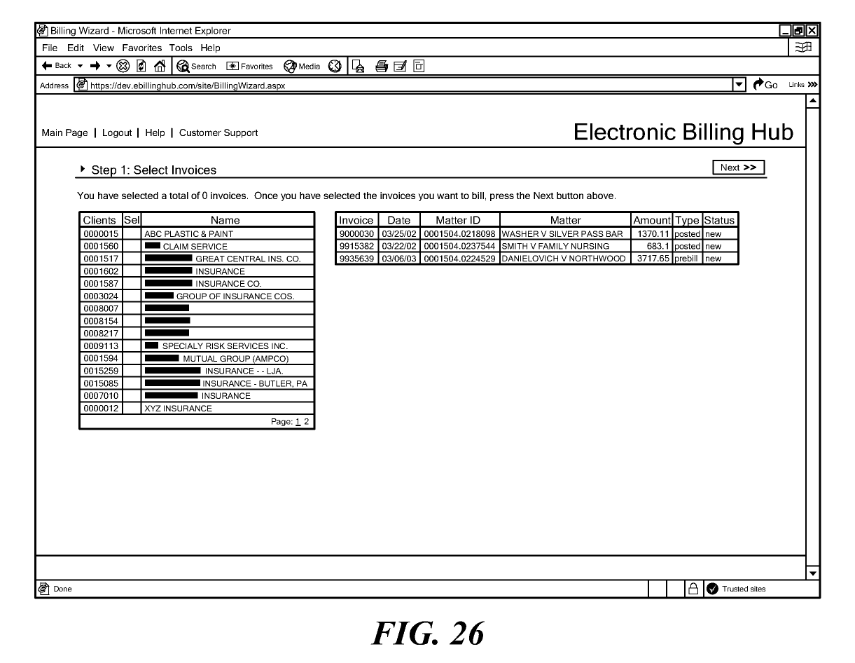

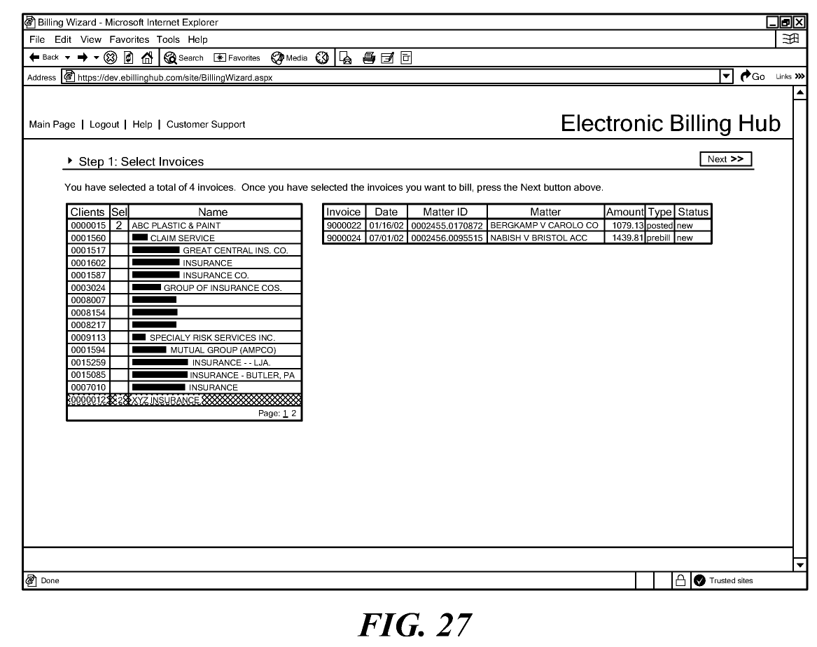

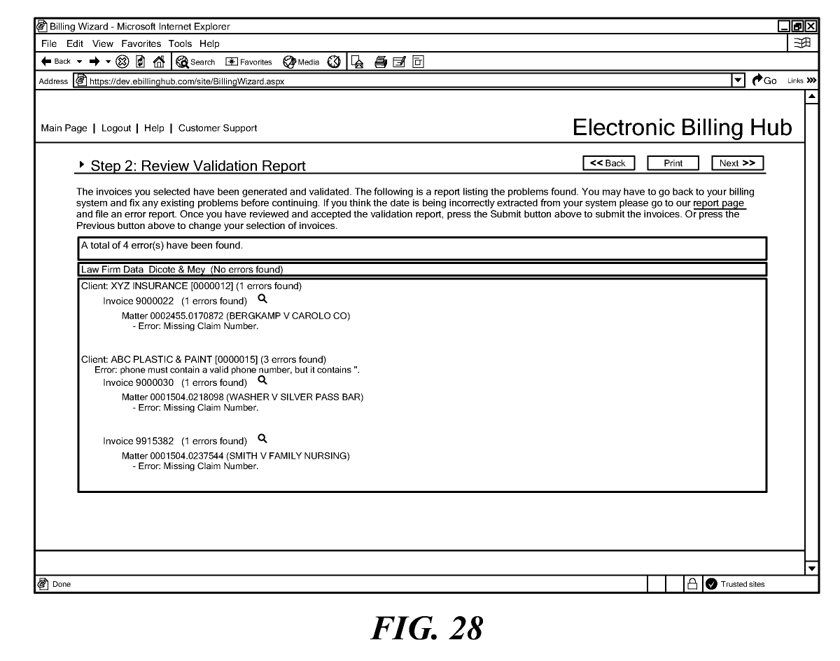

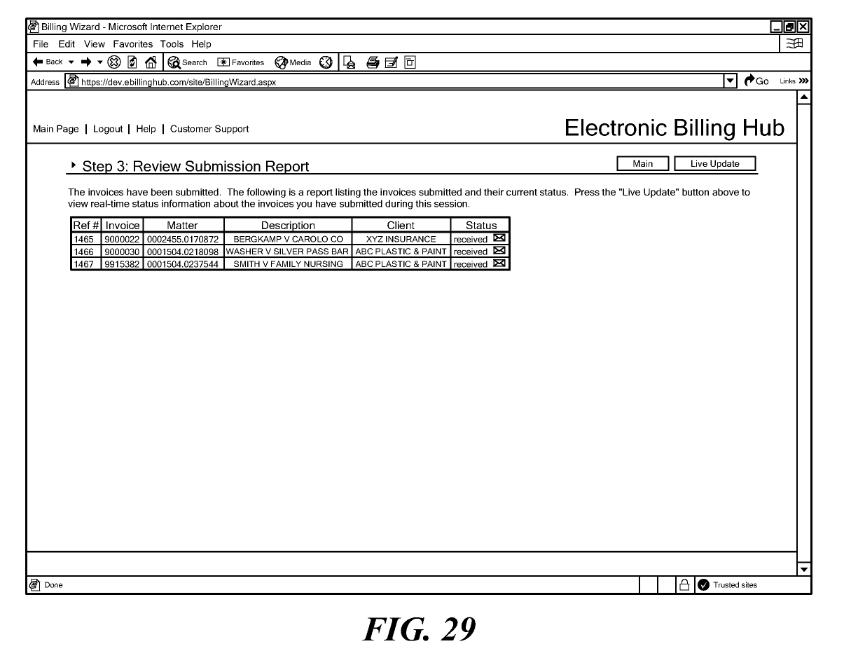

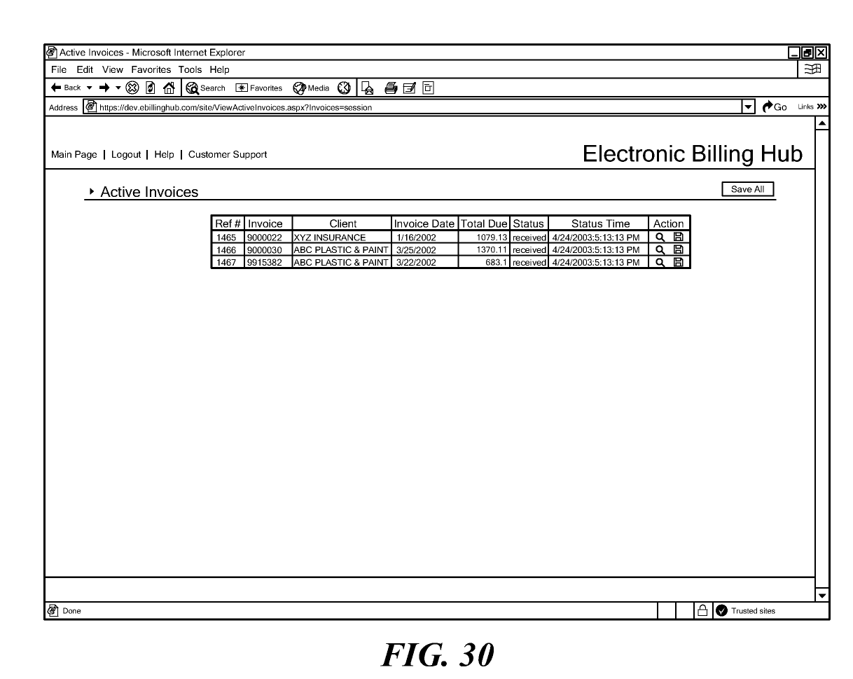

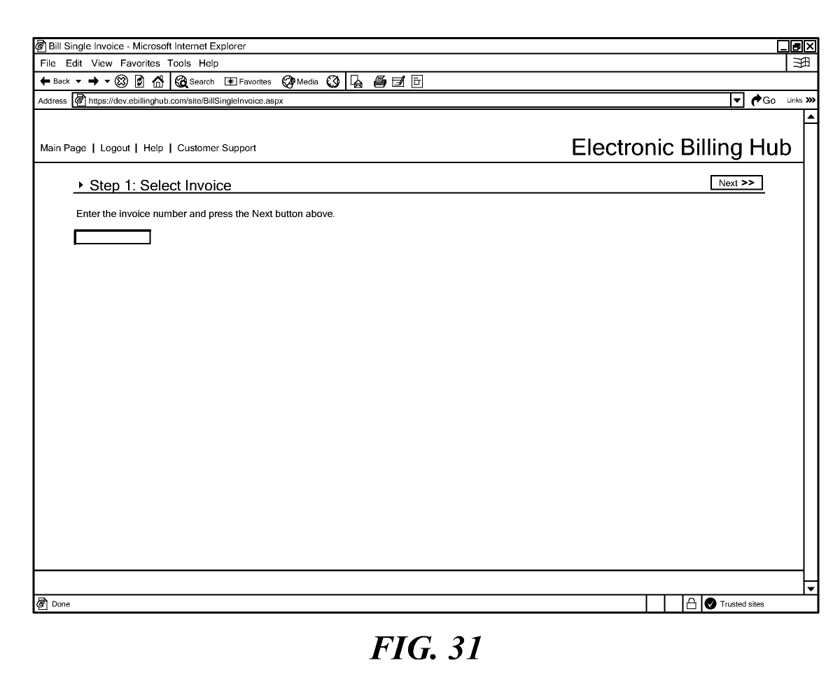

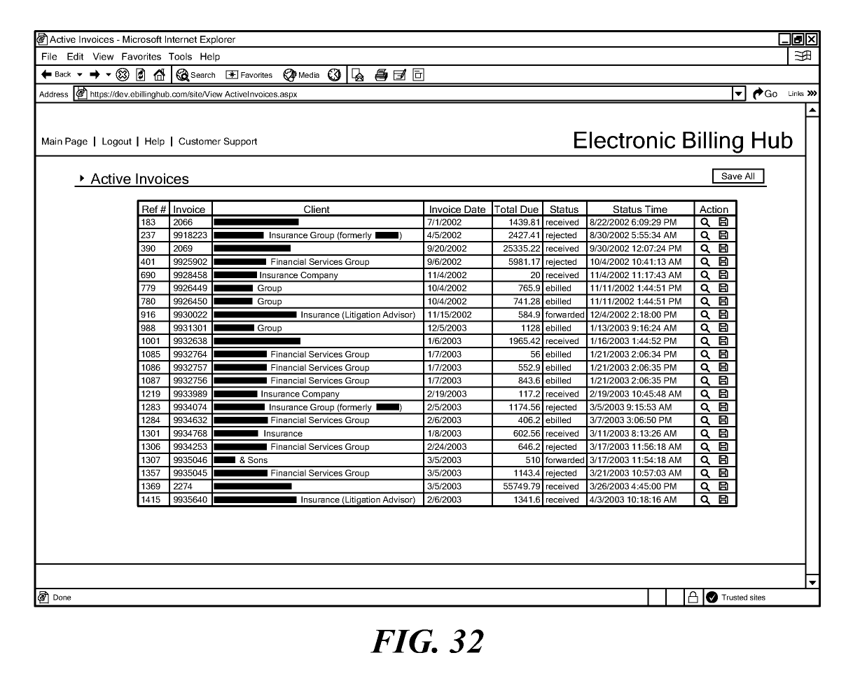

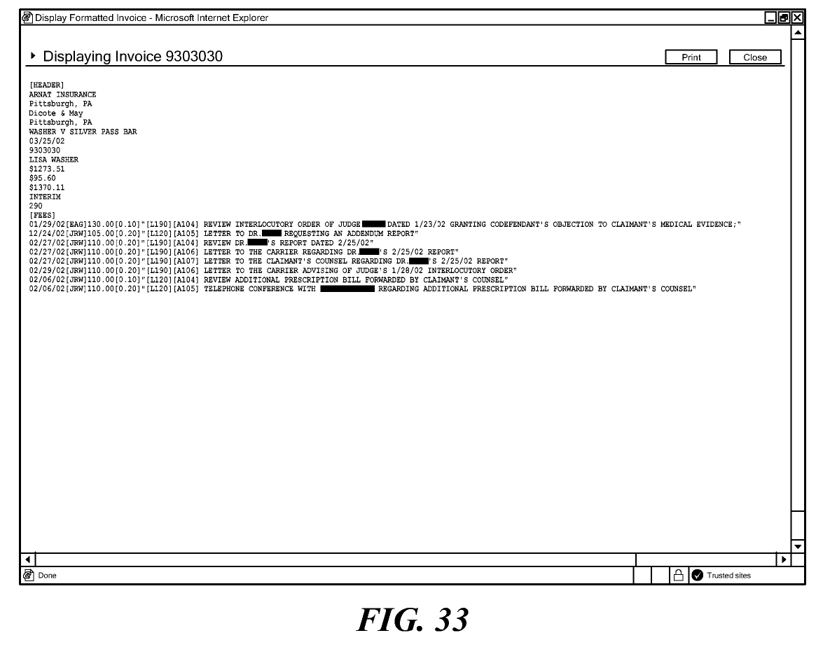

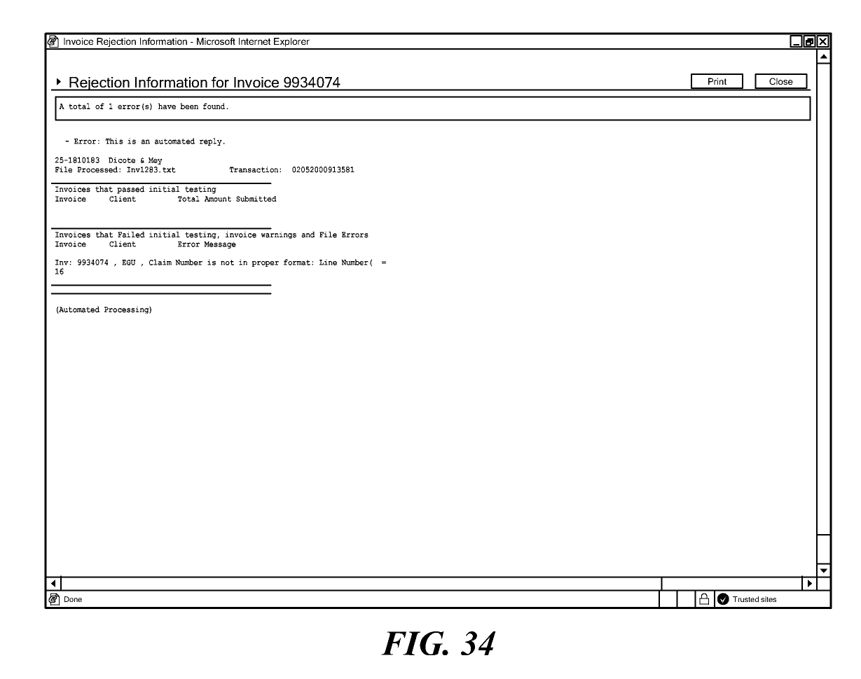

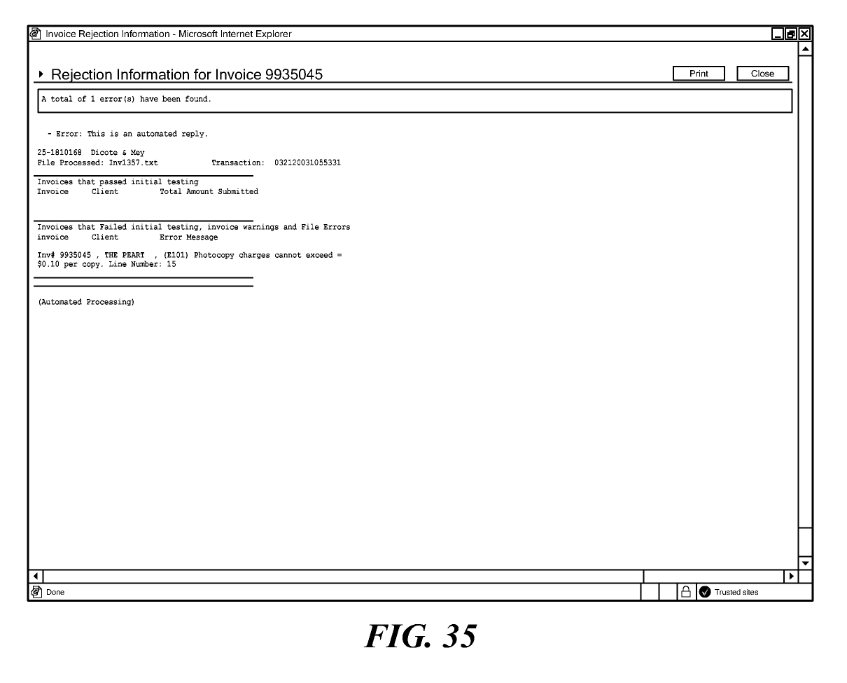

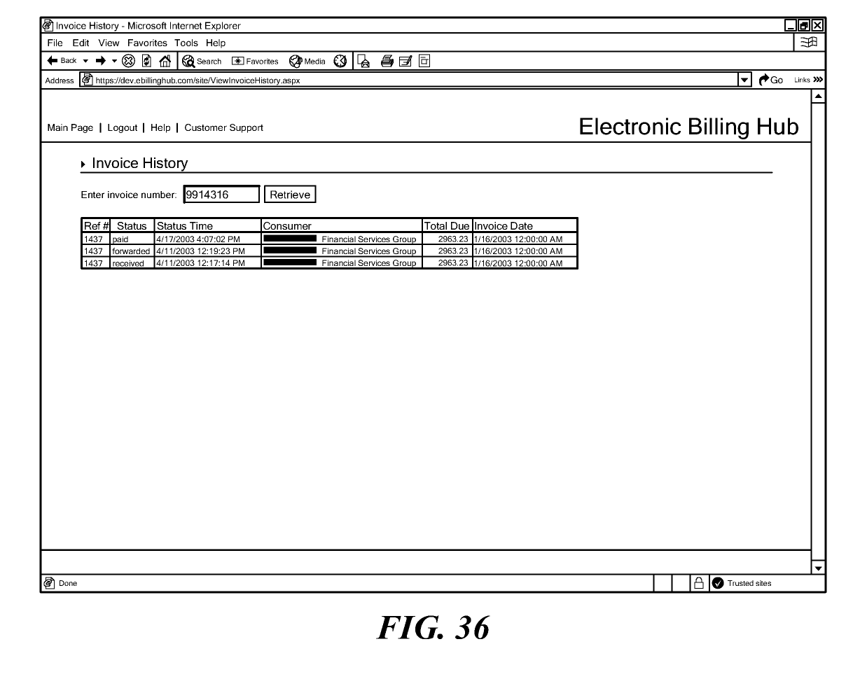

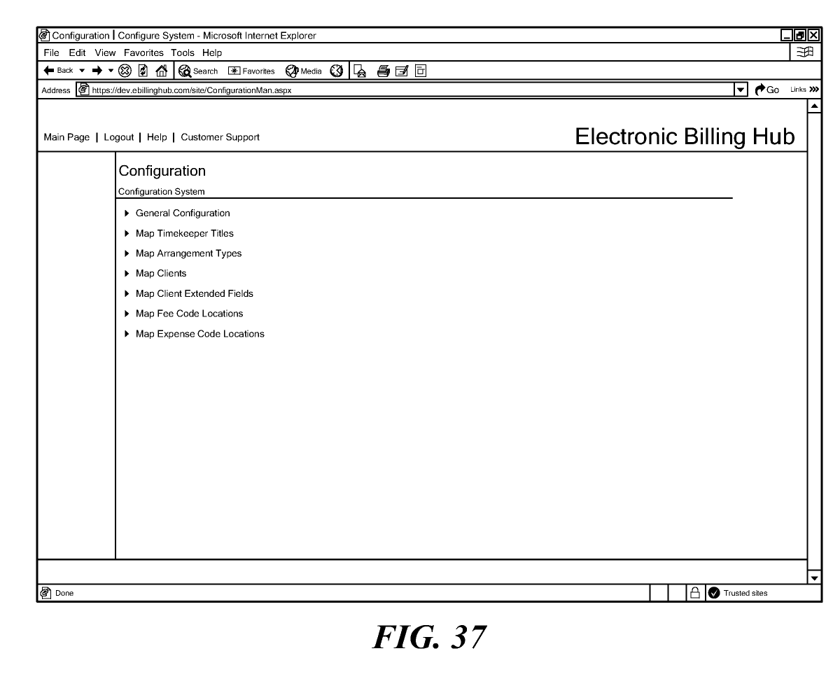

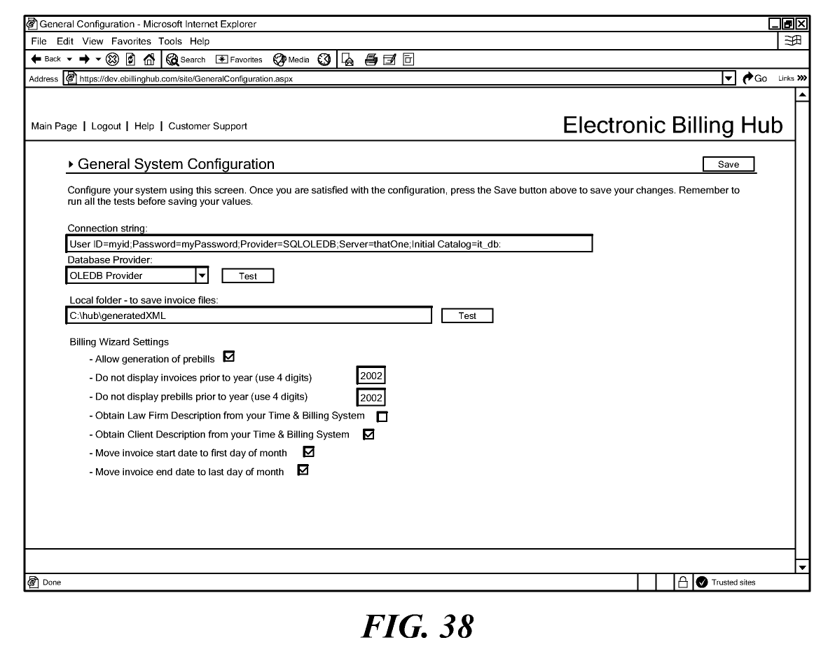

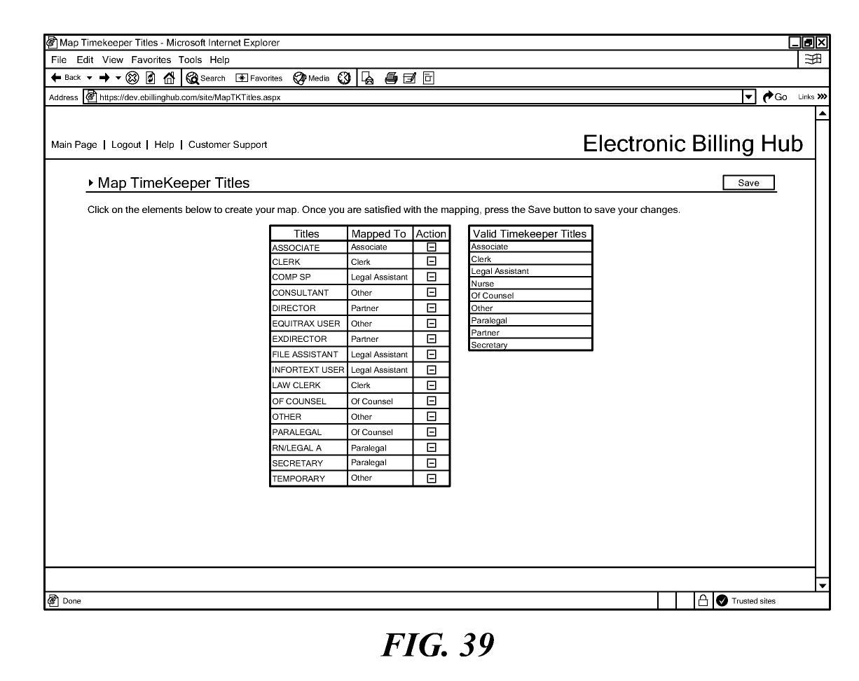

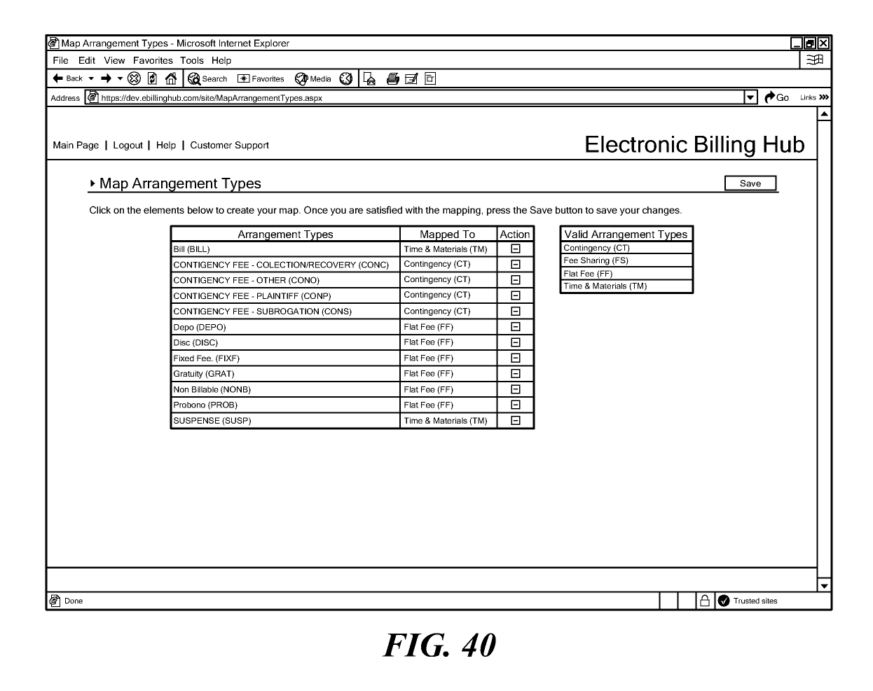

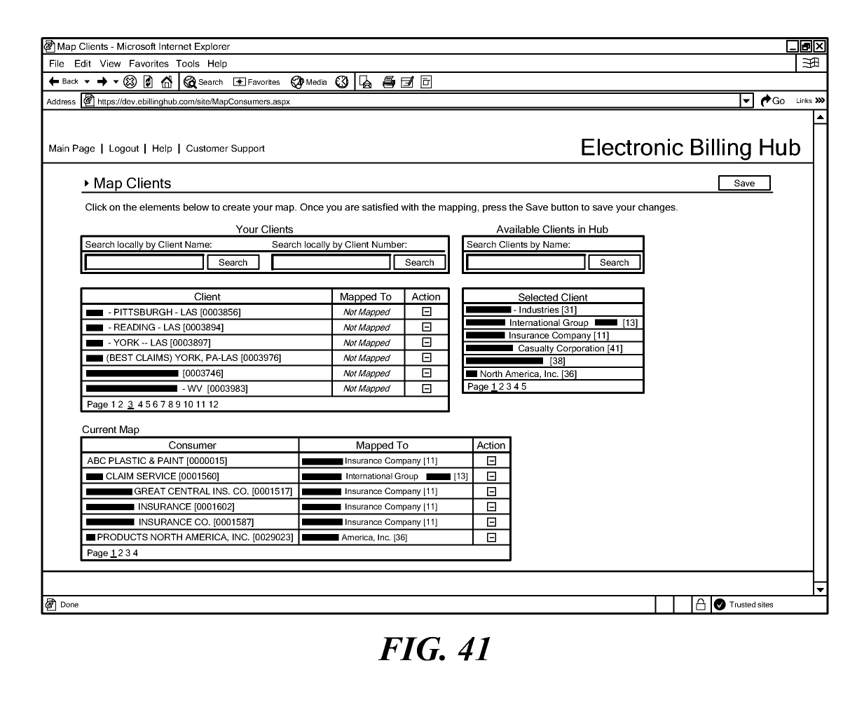

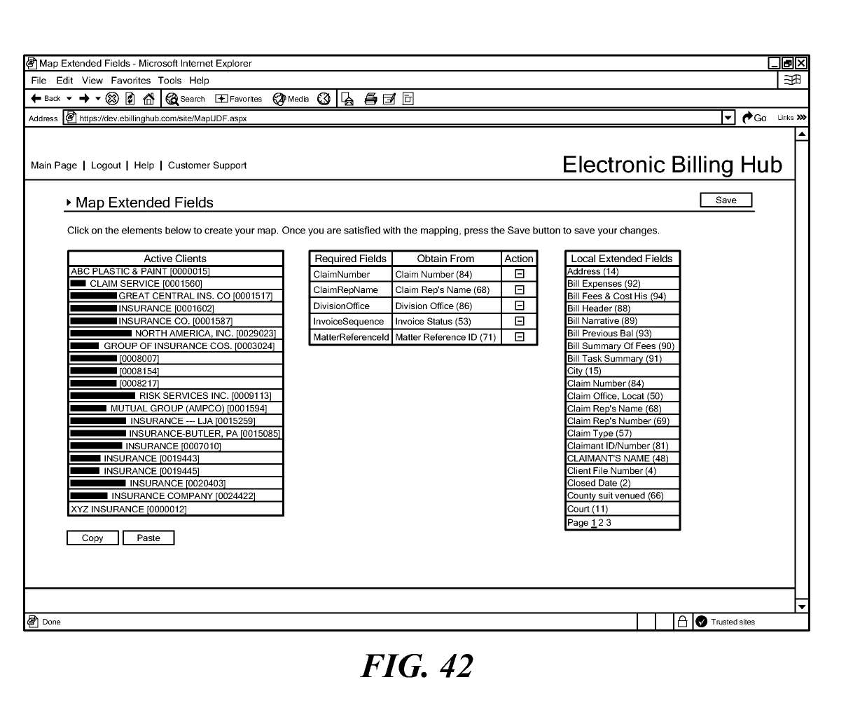

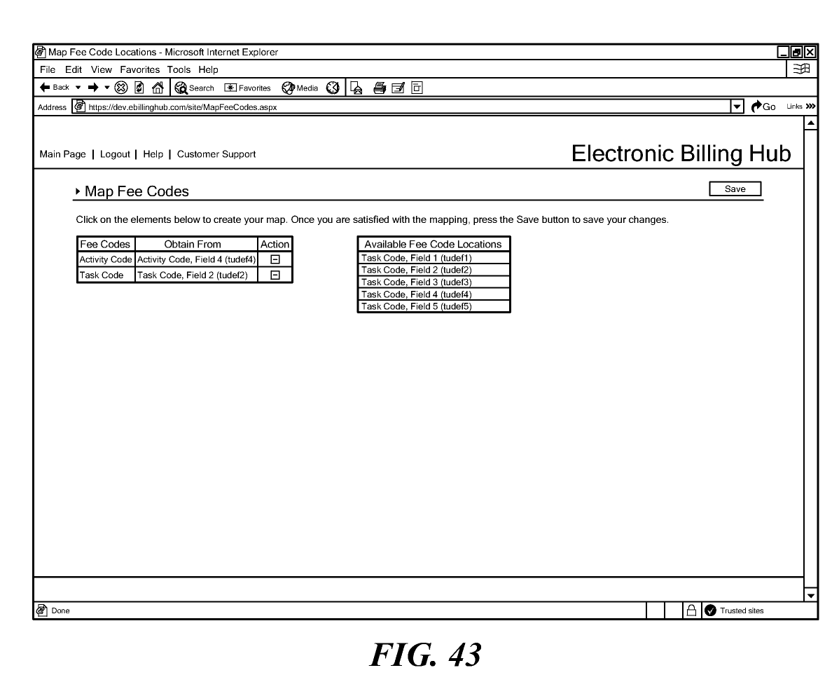

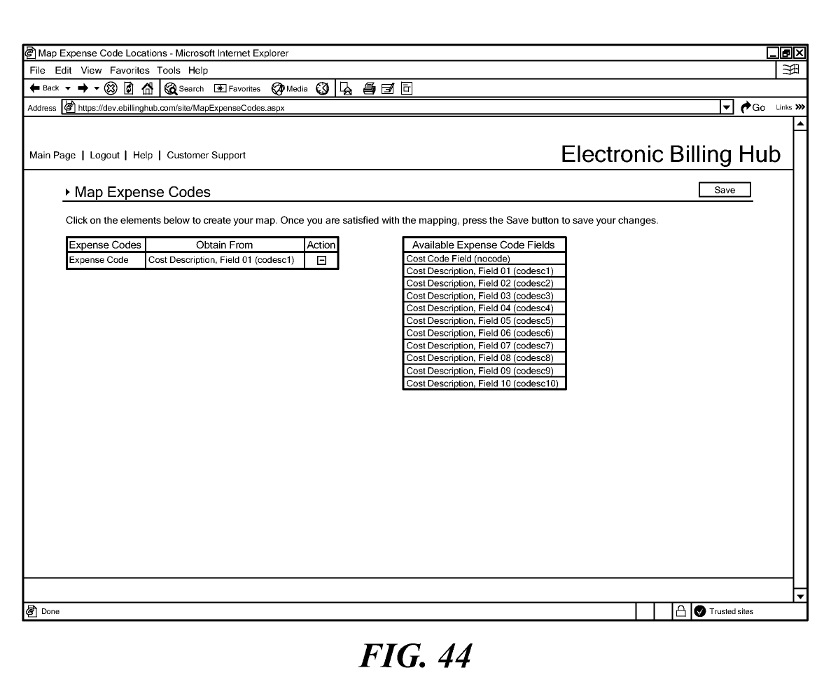

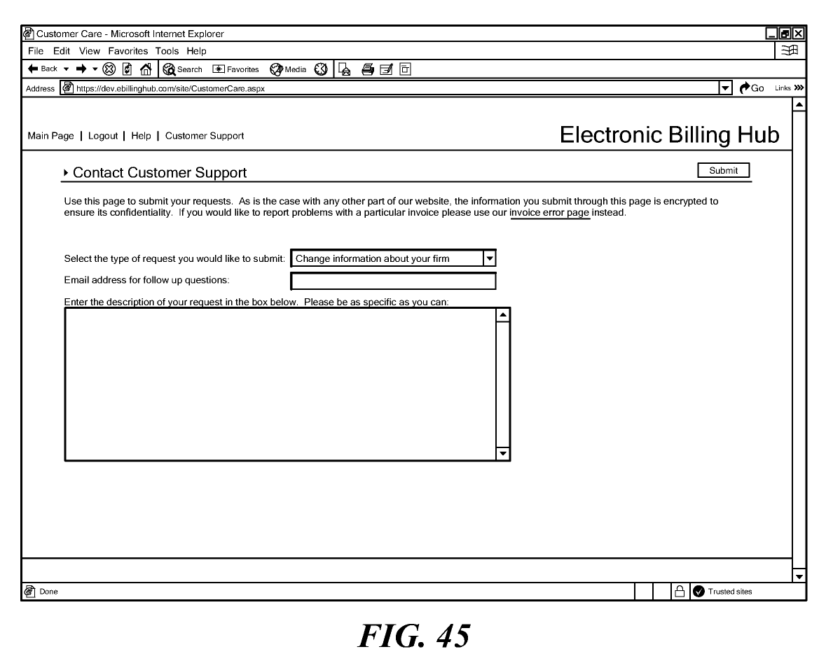

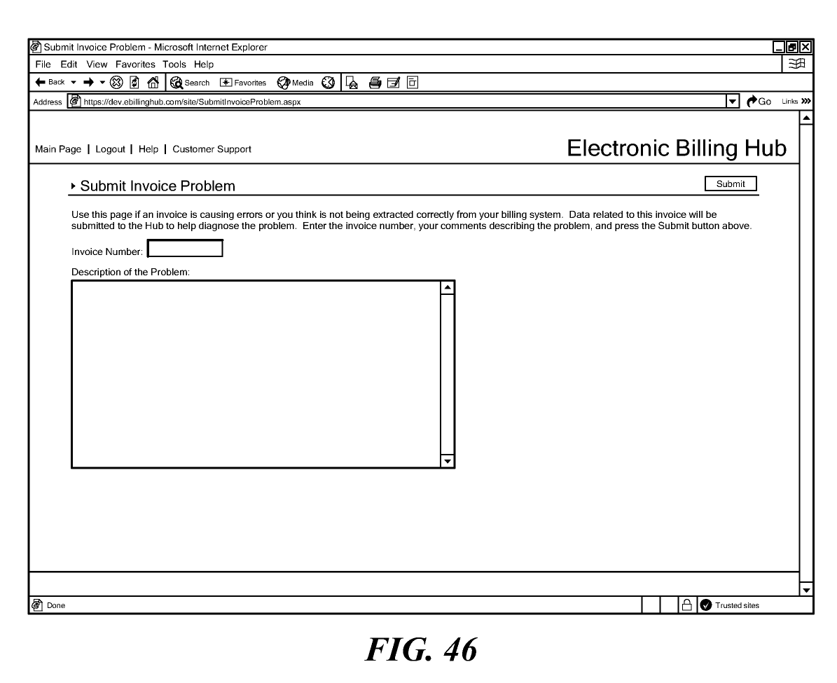

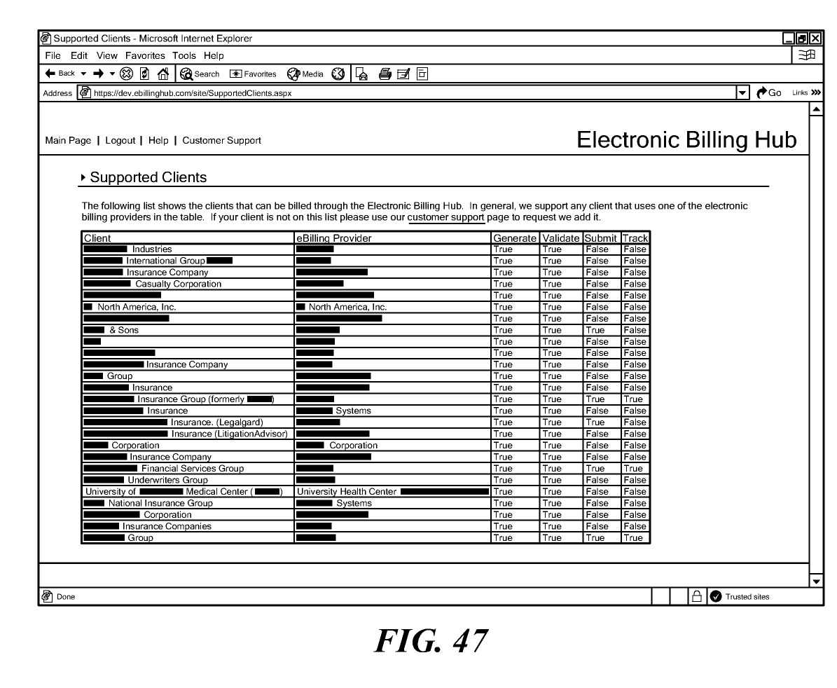

FIGS. 23-47 are screen printouts illustrating an example of an implementation of the system 10 illustrated in FIGS. 1-22. FIGS. 23-28 are screen printouts illustrating the selection of invoices and the validation of billing data. FIGS. 29-32 are screen printout illustrating the submission of invoices. FIG. 33 is a screen printout illustrating the formatted invoice. FIGS. 34-36 are screen printouts illustrating the rejection of invoices and invoice history. FIGS. 37-44 are screen printouts illustrating the configuration of the billing hub. FIGS. 45-47 are screen printouts illustrating the customer support features.

The design of the electronic billing hub system 10 follows a three-tiered software architecture. The first tier presentation layer provides the application Graphic User Interface (GUI). The GUI is isolated from the application layer, meaning that for certain changes made to the business logic, no modifications are necessary to interface system. The second tier application layer allocates the main body of the application to run on a shared host rather than in the service provider's system. The application server does not drive the GUI's, but does share business logic, computations and a data retrieval engine. The third tier database layer provides database management and is dedicated to data file services that can be optimized without using any proprietary database management system languages. The data management tier ensures that the data is consistent throughout the distributed environment through the use of features such as data locking, consistency and replication. Connectivity between tiers can be dynamically altered depending on the user's request for data and services.

This three-tier architecture facilitates software development because each tier can be built and executed on a separate platform. The three-tier architecture readily allows different tiers to be developed in different languages. In one embodiment of the present invention, a graphical interface language or light internet clients (HTML, applets, etc) may be used for the presentation tier. In another embodiment, Visual Basic, VC++, COM, DCOM and Web Services may be used for the application tier. In another embodiment, SQL may be used for the database tier.

While the present invention has been described in conjunction with preferred embodiments thereof, many modifications and variations will be apparent to those of ordinary skill in the art. For example, the techniques of the present invention could be used to benefit the medical field. Service providers, such as hospitals, clinics and doctor offices, that electronically submit claims to a multitude of insurance companies, each typically having different claim formats and claim guidelines could readily benefit from an application of the present invention. Furthermore, the techniques of the present invention could be implemented in a purchasing system in which a business must submit purchase orders to a multitude of individual vendors each requiring different procedures and guidelines.

The techniques of the present invention have application to process to generate invoices for other industries and businesses in which service providers will benefit from isolation from the billing and communication requirements of a multitude of service consumers. The foregoing description and the following claims are intended to cover all such modifications and variations, as well as any other applicable technologies which may appear in the future.

What is claimed is:

1. A computer-assisted billing system comprising:
a first computer system operable by at least one user to enter and store billing data;
a second computer system capable of receiving a billing data file, wherein the second computer system comprises:
means for receiving electronic invoice requirements from a client; and
an invoice generation application, wherein the invoice generation application comprises means for generating a client invoice by formatting the billing data file in compliance with the electronic invoice requirements from the client; and
a universal billing format application in data communication with the first computer system and the second computer system, wherein the universal billing format application comprises:
means for extracting electronic billing data from the first computer system;
means for arranging the billing data from the first computer system into a pre-existing billing data format;
means for generating the billing data file; and
means for electronically transmitting the billing data file to the second computer system.

2. The computer-assisted billing system of claim 1, wherein the invoice requirements comprise content, format and processing restrictions.

3. The computer-assisted billing system of claim 1, the second computer system further comprising means for transmitting the client invoice to the client.

4. The computer-assisted billing system of claim 1, further comprising means for sending an electronic confirmation to the first computer system at the same time, or some time after, the client invoice has been transmitted to the client.

5. The computer-assisted billing system of claim 1, further comprising a validation application in data communication with the first computer system and the second computer system, wherein the validation application comprises:
means for accessing the invoice requirements from the second computer system;
means for accessing the billing data from the first computer system; and
means for determining if the billing data satisfies all the invoice requirements.

6. The computer-assisted billing system of claim 5, wherein the validation application is enacted prior to the extraction of the electronic billing data from the first computer system by the universal billing format application, wherein the validation application further comprises means for determining if the billing data satisfies all invoice requirements.

7. The computer-assisted billing system of claim 6, wherein the validation application further comprises means for authorizing the universal billing format application to generate a billing data file if the billing data satisfies all the invoice requirements.

8. The computer-assisted billing system of claim 6, wherein the validation application further comprises means for notifying the first computer system of a validation failure if the billing data does not satisfy all the invoice requirements.

9. The computer-assisted billing system of claim 8, wherein the means for notifying the service provider of a validation failure comprises a user notification on the first computer system or email.

10. The computer-assisted billing system of claim 8, wherein the means for notifying the service provider of a validation failure comprises means to enter additional billing information.

11. The computer-assisted billing system of claim 1, further comprising a billing data release application operable by an authorizing agent, wherein only the deployment of the data release application transmits billing data from the first computer system to a validation application, the data release application comprising means for electronically transmitting billing data from the first computer system to the universal billing format application.

12. The computer-assisted billing system of claim 1, wherein the universal billing format application resides at least in part on the first computer system.

13. The computer-assisted billing system of claim 1, wherein the universal billing format application resides at least in part on the second computer system.

14. The computer-assisted billing system of claim 1, wherein the universal billing format application resides at least in part on both the first computer system and the second computer system.

15. The computer-assisted billing system of claim 1, wherein the universal billing format application resides external to both the first computer system and the second computer system.

16. The computer-assisted billing system of claim 1, wherein the second computer system comprises means for receiving an acceptance or a reason for rejection of a client invoice from the client.

17. The computer-assisted billing system of claim 16, wherein the second computer system comprises means for recording the reason for rejection of the client invoice.

18. The computer-assisted billing system of claim 17, wherein the second computer system comprises means for determining whether the reason for rejection of the client invoice was caused by an error in the billing data file or a client objection to the content of the billing data supplied to the first computer system by a service provider.

19. The computer-assisted billing system of claim 17, wherein the second computer system comprises a re-calculation application in data communication with the universal billing format application, wherein the re-calculation application comprises means for triggering the universal billing format application to create a new billing data file if the reason for rejection of the client invoice was caused by an error in the billing data file.

20. The computer-assisted billing system of claim 18, wherein the second computer system comprises a clarification application in data communication with the first computer system, wherein the clarification application comprises:
means for allowing the service provider to enter new or additional information in response to the rejection and initiate the generation of a second billing data file; and
means for triggering the universal billing format application to create a new billing data file.

21. The computer-assisted billing system of claim 1, wherein the second computer system maintains a record of all transactions, including: all activations of a data release application, a validation application, a universal billing format application, an invoice generation application, an acceptance or rejection of a client invoice and any entry of billing requirements.

22. The computer-assisted billing system of claim 21, wherein the second computer system comprises a report generating application, wherein the report generating application comprises:
means for generating an account for individual service providers and/or clients; and
means for allowing service providers and clients to review their own transactions relating to the generation of the relevant client invoice.

23. The computer-assisted billing system of claim 1, wherein the second computer system comprises a rejected invoice learning application, wherein the rejected invoice learning application comprises:
means for recording the reasons a client rejects a client invoice;
means for comparing the rejection to other like billing data; and
means for subsequently requiring the service provider to clarify the billing data in a validation process.

24. The computer-assisted billing system of claim 1, further comprising means for sending a status report to service providers, wherein the status of billing data can be identified.

25. The computer-assisted billing system of claim 1, wherein the data communication occurs through the Internet or a wireless communication device.

26. The computer-assisted billing system of claim 1, wherein the billing data comprises: timekeeper identification information, timekeeper title, timekeeper practice area, timekeeper billing rate, client identification information, case identification information, case description, fee arrangement information, contact names, responsible party information, billing addresses, dates, party names, party identification information, invoice identification number, invoice amounts, billing activity, billing descriptions, expenses and disbursement information, expense codes, adjuster information, applicable coverage, policy number and invoice description information.

27. The computer-assisted billing system of claim 1, wherein the means for arranging the billing data from the first computer system into a pre-existing billing data format comprises formatting the billing data into standard fields.

28. A computer-implemented method of generating an invoice, comprising:
entering and storing data into a first computer system;
extracting electronic billing data from the first computer system;
arranging the billing data from the first computer system into a pre-existing billing data format;
generating a billing data file;
electronically transmitting the billing data file to a second computer system capable of receiving the billing data file;
receiving invoice requirements from a client; and
generating a client invoice from the second computer system by formatting the billing data file in compliance with the invoice requirements.

29. The computer-implemented method of generating an invoice of claim 28, further comprising transmitting the client invoice to the client.

30. The computer-implement method of generating an invoice of claim 28, further comprising validating the billing data from the first computer system by determining if the billing data satisfies all the invoice requirements.

31. The computer-implemented method of generating an invoice of claim 28, further comprising authorizing release of the billing data by selecting to process a client's billing data.

32. A computer-readable medium having stored thereon instructions which, when executed by a processor, cause the processor to perform the steps of:
extracting electronic billing data from a first computer system;
arranging the billing data from a first computer system into a pre-existing billing data format;
generating a billing data file;
electronically transmitting the billing data to a second computer systems
receiving invoice requirements;
receiving the billing data file;
generating a client invoice by formatting the billing data file in compliance with the invoice requirements; and
transmitting the client invoice to a client.

33. The computer-readable medium of claim 32, having stored thereon additional instructions which, when executed by a processor, cause the processor to perform the additional steps of:
accessing the billing data from the first computer system;
accessing the invoice requirements from the second computer system; and
determining if the billing data satisfies the invoice requirements.

34. An apparatus, comprising:
means for extracting electronic billing data from a first computer system;
means for arranging the billing data from a first computer system into a pre-existing billing data format;
means for generating a billing data file;
means for electronically transmitting the billing data to a second computer system;
means for receiving invoice requirements;
means for receiving the billing data file;
means for generating a client invoice by formatting the billing data file in compliance with the invoice requirements; and
means for transmitting the client invoice to a client.

35. The apparatus of claim 34, further comprising:
means for accessing the billing data from the first computer system;
means for accessing the invoice requirements from the second computer system; and
means for determining if the billing data satisfies the invoice requirements.

36. A system, comprising:
a processor; and
a memory in communication with the processor, the memory having stored thereon a set of ordered data and instructions which, when executed by the processor, cause the processor to:
extract electronic billing data from a first computer system;
arrange the billing data from a first computer system into a pre-existing billing data format;
generate a billing data file;
electronically transmit the billing data to a second computer system;
receive invoice requirements from a client; and
generate a client invoice from the second computer system by formatting the billing data file in compliance with the invoice requirements.
